(19) United States
(12) Patent Application Publication
(10) Pub. No.: US 2022/0300597 A1
(43) Pub. Date: Sep. 22, 2022

(54) AUTHENTICATOR MANAGEMENT DEVICE, COMPUTER READABLE MEDIUM AND AUTHENTICATOR MANAGEMENT METHOD

(71) Applicant: Mitsubishi Electric Corporation, Tokyo (JP)

(72) Inventors: Manabu MISAWA, Tokyo (JP); Yuta ATOBE, Tokyo (JP); Yuya TAKATSUKA, Tokyo (JP); Nobuaki MATOZAKI, Tokyo (JP); Yukio IZUMI, Tokyo (JP)

(73) Assignee: Mitsubishi Electric Corporation, Tokyo (JP)

(21) Appl. No.: 17/831,991

(22) Filed: Jun. 3, 2022

Related U.S. Application Data
(63) Continuation of application No. PCT/JP2020/003001, filed on Jan. 28, 2020.

(51) Int. Cl. G06F 21/35; G06F 21/78; G06F 21/55; H04L 9/32

(52) U.S. Cl. CPC G06F 21/35; G06F 21/78; G06F 21/554; H04L 9/3242

(57) ABSTRACT

An attack detection device (501) includes a group generation unit (30), a log management unit (40), an authenticator generation unit (90) and a graph management unit (60). The group generation unit (30) generates an authenticator graph (D36) including a plurality of pieces of correspondence information wherein a plurality of logs and an identifier to identify an authenticator generated by using the plurality of logs are associated. The log management unit (40) manages the plurality of logs used for generation of an authenticator identified by the identifier in the authenticator graph (D36). The authenticator generation unit (90) generates the authenticator identified by the identifier for each identifier in the authenticator graph (D36) from the plurality of logs. The graph management unit (60) manages the authenticator graph (D36) and the authenticator generated.

### CROSS REFERENCE TO RELATED APPLICATIONS

This application is a Continuation of PCT International Application No. PCT/JP2020/003001, filed on Jan. 28, 2020, which is hereby expressly incorporated by reference into the present application.

### TECHNICAL FIELD

The present disclosure relates to an authenticator management device to manage an authenticator.

### BACKGROUND ART

When a cyberattack against an in-vehicle system is detected, the in-vehicle system refers to a log in order to properly detect what cyberattack has been made.

However, when a log generated in an in-vehicle system is illegally rewritten, there exists a risk that a cyberattack against the in-vehicle system cannot be detected. Therefore, when a log is referred to due to cyberattack detection, it is necessary to verify whether the log has been falsified. Use of an authenticator such as a hash value or a MAC (message authentication code) may be an effective countermeasure for verification of log falsification. As log falsification, there exists falsification such as addition of a log, overwriting of a log, and deletion of a log.

In a conventional technique, a method to detect falsification of a program by using an authenticator such as a hash value or a MAC is disclosed (for example, Patent Literature 1). In Patent Literature 1, an authenticator is assigned to each of a plurality of divided programs obtained by dividing a program. It is conceivable that a detection method of falsification of a program in Patent Literature 1 is applied to a detection method of log falsification.

However, when an authenticator is assigned to each of a plurality of logs, there is a problem that a burden to generate a plurality of authenticators and a burden to manage a plurality of authenticators occur.

### CITATION LIST

### Patent Literature

Patent Literature 1: WO2019-012952 A

### SUMMARY OF INVENTION

### Technical Problem

An objective of the present disclosure is to solve the problem that a burden to generate a plurality of authenticators and a burden to manage a plurality of authenticators occur.

### Solution to Problem

An authenticator management device according to the present invention includes:

a group generation unit to generate a correspondence information group including a plurality of pieces of correspondence information, a piece of correspondence information associating two or more logs included in a plurality of logs of feature information to represent a feature of a system being an object of a cyberattack, and to specify the plurality of logs, with an identifier to identify an authenticator to authenticate validity of the two or more logs;

a group management unit to output an authenticator generation request that includes the two or more logs indicated in the piece of correspondence information, and that requests generation of an authenticator identified by the identifier indicated in the piece of correspondence information, and to output, by referring to the correspondence information group in a case wherein a log reference request to request a log to be referred to is received, a verification request that includes a plurality of logs corresponding to the identifier corresponding to the log requested to be referred to by the log reference request, and the authenticator corresponding to the log requested to be referred to by the log reference request via the identifier;

an authenticator generation unit to generate an authenticator identified by the identifier indicated in the piece of correspondence information by using the two or more logs included in the authenticator generation request; and

an authenticator verification unit to verify validity of the plurality of logs included in the verification request by using the authenticator and the plurality of logs included in the verification request, and to output a verification result.

### Advantageous Effects of Invention

According to the present disclosure, since an authenticator management device includes a group generation unit to generate a correspondence information group based on two or more logs specified by feature information, it is possible to provide the authenticator management device with a small burden to generate a plurality of authenticators and a small burden to manage a plurality of authenticators.

### BRIEF DESCRIPTION OF DRAWINGS

FIG. 1 is a diagram according to a first embodiment, and is a diagram illustrating a hardware configuration of an attack detection device 501.

FIG. 2 is a diagram according to the first embodiment, and is a diagram illustrating generation of a MAC and authentication of the MAC, in a case wherein the MAC is used as an authenticator.

FIG. 3 is a diagram according to the first embodiment, and is a diagram to explain an authenticator graph D36.

FIG. 4 is a diagram according to the first embodiment, and is a diagram illustrating the authenticator graph D36 generated by a group generation unit 30.

FIG. 5 is a diagram according to the first embodiment, and is a diagram illustrating attack detection information 11 included in an attack detection unit 10.

FIG. 6 is a diagram according to the first embodiment, and is a diagram illustrating data exchanged between components of the attack detection device 501.

FIG. 7 is a diagram according to the first embodiment, and is a flowchart illustrating an operation to generate a pertinent authenticator graph D64a by the attack detection device 501.

FIG. 8 is a diagram according to the first embodiment, and is a flowchart of an operation to update an authenticator at the time of updating a log by the attack detection device 501.

FIG. 9 is a diagram according to the first embodiment, and is a diagram to supplement FIG. 8.

FIG. 10 is a diagram according to the first embodiment, and is a flowchart illustrating an operation of authenticator verification at the time when the attack detection device 501 detects an attack.

FIG. 11 is a diagram according to the first embodiment, and is a diagram to supplement FIG. 10.

FIG. 12 is a diagram according to the first embodiment, and is a flowchart illustrating an operation of the attack detection device 501 when the attack detection information 11 is updated.

FIG. 13 is a diagram according to the first embodiment, and is a diagram to supplement FIG. 12.

FIG. 14 is a diagram according to a second embodiment, and is a diagram to illustrate a functional configuration of an attack detection device 502.

FIG. 15 is a diagram according to a third embodiment, and is a diagram illustrating a flow of data between functional elements of an attack detection device 503.

FIG. 16 is a diagram according to the third embodiment, and is a flowchart illustrating an operation to generate an authenticator by the attack detection device 503.

FIG. 17 is a diagram according to the third embodiment, and is a diagram to supplement FIG. 16.

FIG. 18 is a diagram according to the third embodiment, and is a diagram illustrating a state wherein an intermediary data generation unit 310 generates an authenticator D96 from intermediary data generated in the past.

FIG. 19 is a diagram according to the third embodiment, and is a flowchart illustrating an operation to verify an authenticator by the attack detection device 503.

FIG. 20 is a diagram according to the third embodiment, and is a diagram to supplement FIG. 19.

FIG. 21 is a diagram according to a fourth embodiment, and is a diagram illustrating a flow of data in an attack detection device 504.

FIG. 22 is a diagram according to the fourth embodiment, and is a diagram illustrating a state wherein a counter value is reflected to an authenticator.

FIG. 23 is a diagram according to the fourth embodiment, and is a flowchart illustrating an operation at the time when a counter value of a counter 410 is updated.

FIG. 24 is a diagram according to the fourth embodiment, and is a diagram to supplement FIG. 23.

FIG. 25 is a diagram according to a fifth embodiment, and is a diagram illustrating a flow of data in an attack detection device 505.

FIG. 26 is a diagram according to the fifth embodiment, and is a diagram explaining an acquisition frequency of a log.

FIG. 27 is a diagram according to the fifth embodiment, and is a flowchart illustrating an operation to generate an authenticator graph D36 based on a log acquisition frequency D43 by the group generation unit 30.

FIG. 28 is a diagram according to the fifth embodiment, and is a diagram to supplement FIG. 27.

FIG. 29 is a diagram according to a sixth embodiment, and is a diagram illustrating a hardware configuration of an attack detection device 506.

FIG. 30 is a diagram according to the sixth embodiment, and is another diagram illustrating the hardware configuration of the attack detection device 506.

### DESCRIPTION OF EMBODIMENTS

Hereinafter, embodiments of the present invention will be described using diagrams. In each diagram, the same or corresponding parts are denoted by the same reference numerals. In description of the embodiments, with respect to the same elements or corresponding parts, description is omitted or simplified appropriately.
(1) Attack detection devices to be described in the first embodiment through the sixth embodiment below are authenticator management devices, an attack detection program is an authenticator management program, and an attack detection method is an authenticator management method.
(2) In the following embodiments, “interface” is denoted by IF.
(3) In the following embodiments, parentheses for each process in flowcharts indicate the subject of operations.
(4) While logs appear in the following embodiments, logs are electronic data. Logs mean log data.
(5) In the diagrams of the following embodiments, a communication log, a process log and an authentication log indicated in a log acquisition unit 20 indicate update data when update occurs. Otherwise, a communication log, a process log and an authentication log indicated in the log acquisition unit 20 may be an entire log including update data.

### First Embodiment

***Explanation of Configuration***

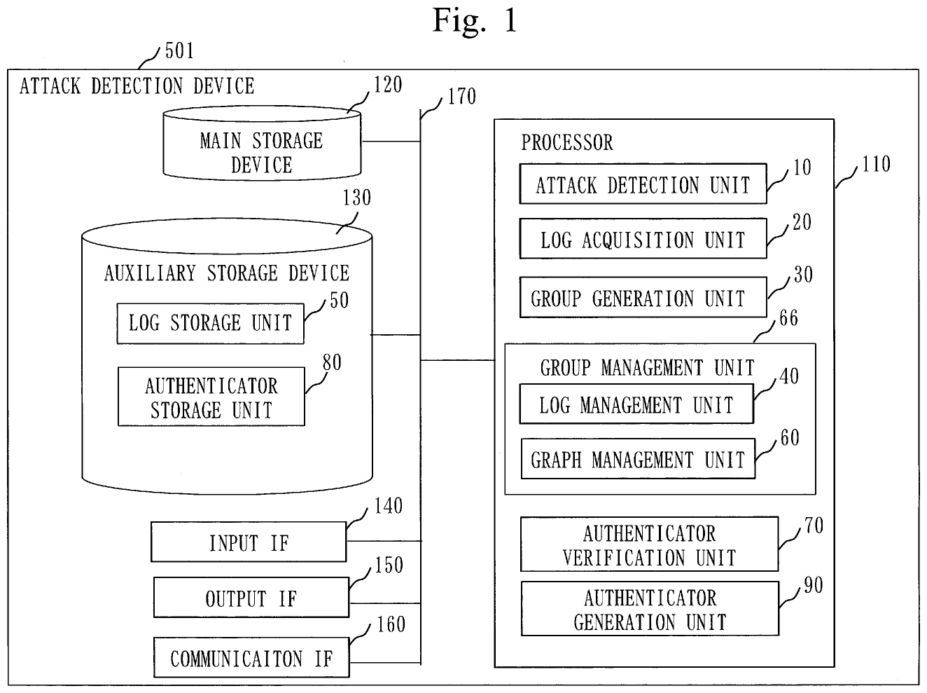

Description is made on an attack detection device 501 in the first embodiment with reference to FIG. 1 through FIG. 13.

FIG. 1 illustrates a hardware configuration of the attack detection device 501. The attack detection device 501 includes a processor 110, a main storage device 120, an auxiliary storage device 130, an input IF 140, an output IF 150 and a communication IF 160, as hardware components. These hardware components are connected via a signal line 170.

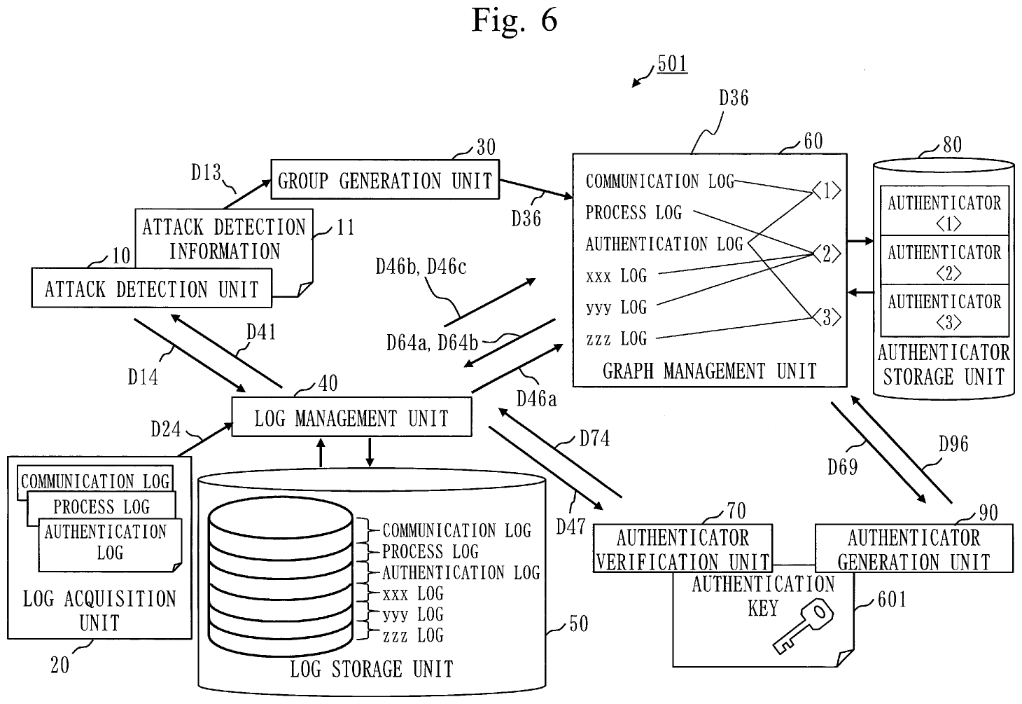

The attack detection device 501 includes, as functional components, an attack detection unit 10, a log acquisition unit 20, a group generation unit 30, a log management unit 40, a graph management unit 60, an authenticator verification unit 70 and an authenticator generation unit 90. The log management unit 40 and the graph management unit 60 constitute a group management unit 66.In FIGS. 6, 9, 11, 13, 14, 15, 17, 20, 21, 24, 25 and 28, description of the group management unit 66 is omitted.

It is not required to have the group generation unit 30 and the group management unit 60 exist in a same device. When processing in the group generation unit 30 is heavy, by making the group generation unit 30 and the graph management unit 60 exist in different devices, it is possible to reduce the load of an in-vehicle system whose resources are limited.

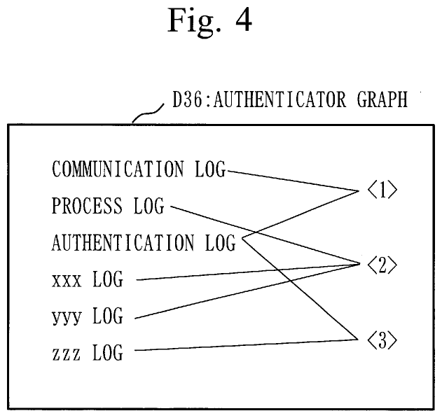

The group generation unit 30 generates a correspondence information group including a plurality of pieces of correspondence information. A piece of correspondence information associates two or more logs included in a plurality of logs in feature information that represents features of a system to be an object of a cyberattack, and that specifies the plurality of logs, with an identifier to identify an authenticator to authenticate validity of the two or more logs. The correspondence information and the correspondence information group will be described in description for FIG. 4.

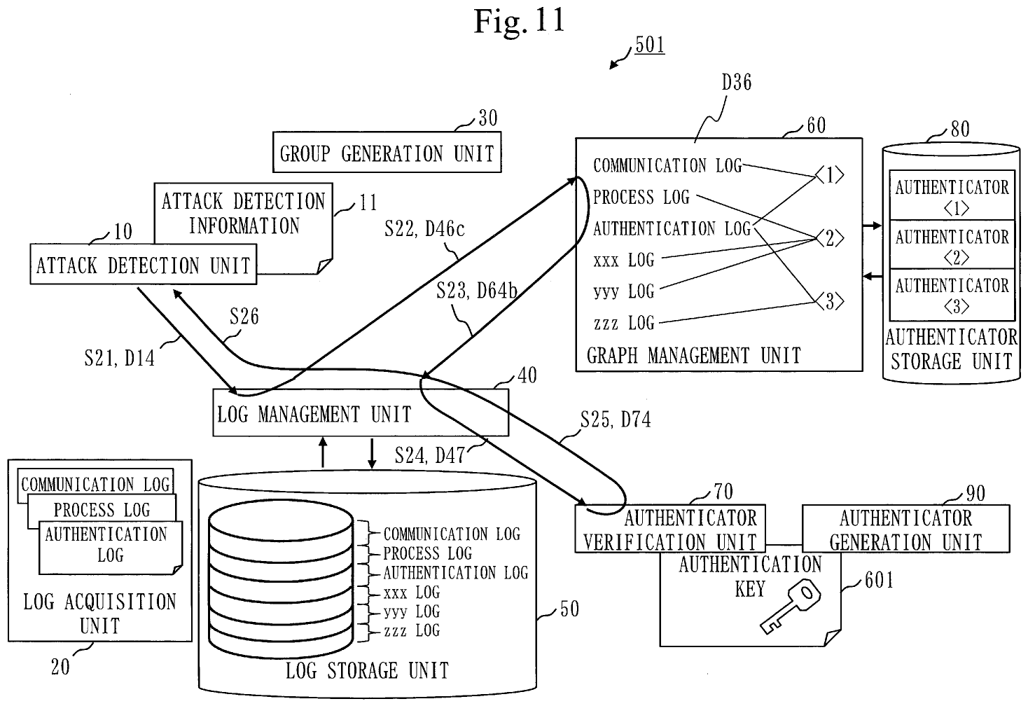

The feature information is attack detection information 11 wherein a plurality of logs are associated for each rule of a plurality of rules to detect a cyberattack. The attack detection information 11 will be described in description for FIG. 11. Otherwise, the feature information is update frequency information 44 wherein an update frequency of a plurality of logs is registered. The update frequency information 44 will be described in a fifth embodiment.

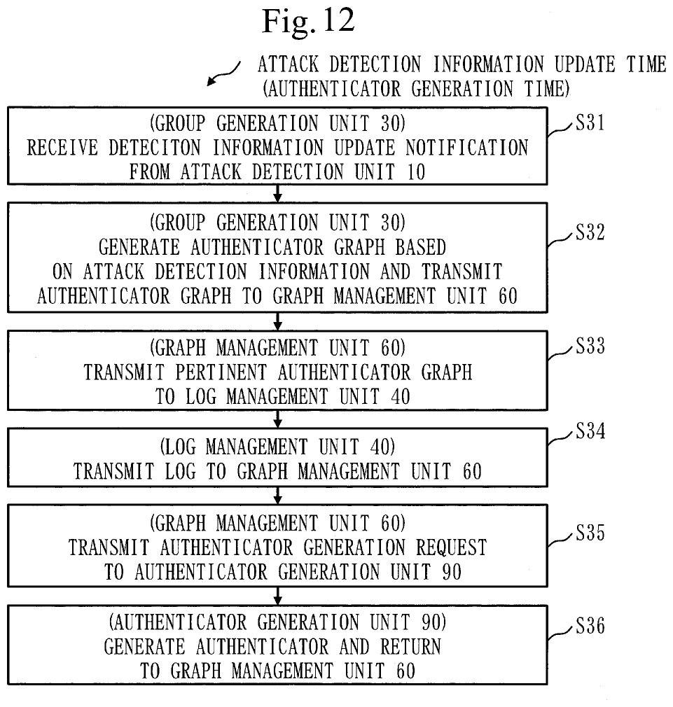

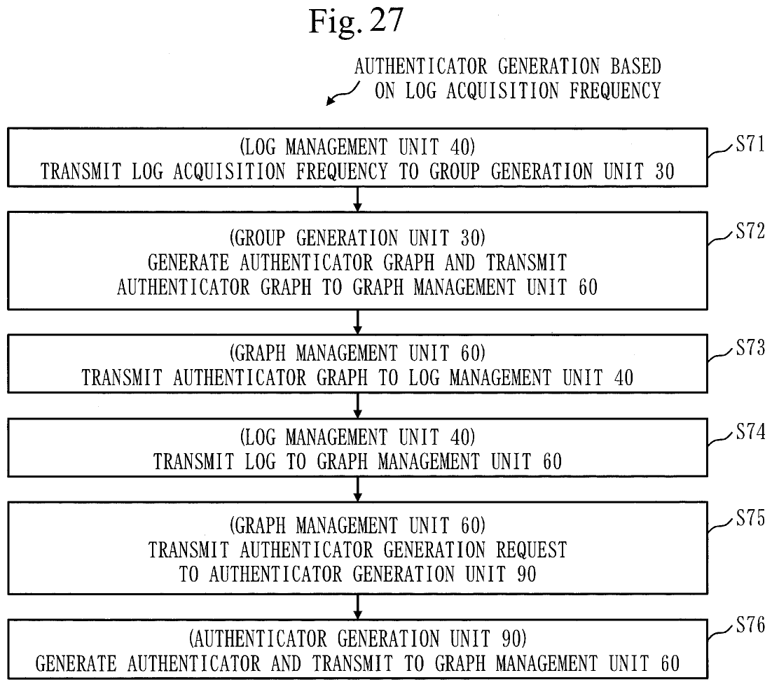

A group management unit 66 outputs an authenticator generation request D69 that includes the two or more logs indicated in the piece of correspondence information, and that requests generation of an authenticator identified by the identifier indicated in the piece of correspondence information. Generation of the authenticator generation request D69 by the group management unit 66 will be described in step S35 of FIG. 12 and step S75 of FIG. 27 in the fifth embodiment.

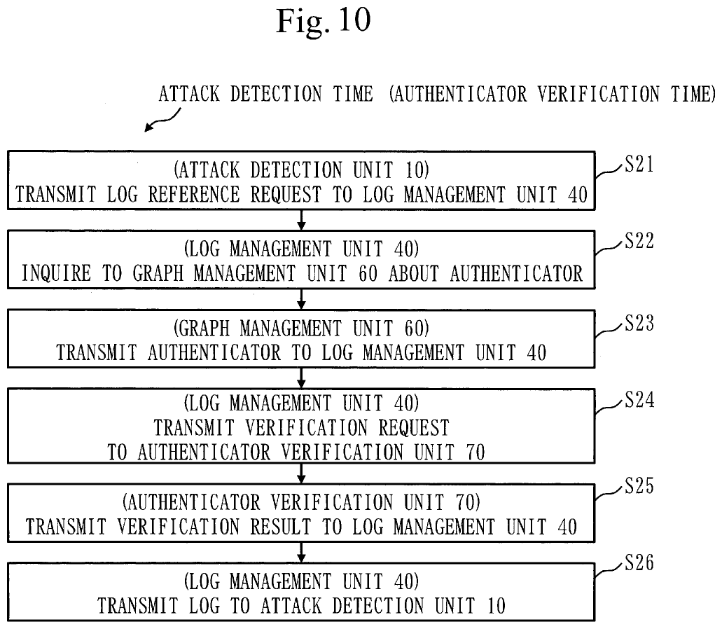

The group management unit 66 outputs, by referring to the correspondence information group in a case wherein a log reference request D14 to request a log to be referred to is received, a verification request D47 that includes a plurality of logs corresponding to the identifier corresponding to the log requested to be referred to by the log reference request D14, and the authenticator corresponding to the log requested to be referred to by the log reference request D14 via the identifier. Output of the verification request D47 by the group management unit 66 will be described in description for FIG. 10 and FIG. 11.

An authenticator generation unit 90 generates an authenticator identified by the identifier indicated in the correspondence information by using the two or more logs included in the authenticator generation request D69. Generation of an authenticator by the authenticator generation unit 90 will be described in step S36 of FIG. 12 and step S76 of FIG. 27 in the fifth embodiment.

An authenticator verification unit 70 verifies validity of a plurality of logs included in the verification request D47 by using the authenticator and the plurality of logs included in the verification request D47, and outputs a verification result. Verification of an authenticator by the authenticator verification unit 70 will be described in step S25 of FIG. 10.

The graph management unit 60 manages the correspondence information group being an authenticator graph, and the authenticator generated. The authenticator verification unit 70 performs a verification process of the authenticator with an authentication key 601. The authenticator generation unit 90 performs a generation process of the authenticator with the authentication key 601. Further, as storage units, a log storage unit 50 and an authenticator storage unit 80 are included. The log storage unit 50 stores a communication log, a process log, an authentication log, an xxx log, a yyy log and a zzz log. The authenticator storage unit 80 stores an authenticator <1>, an authenticator <2> and an authenticator <3>.

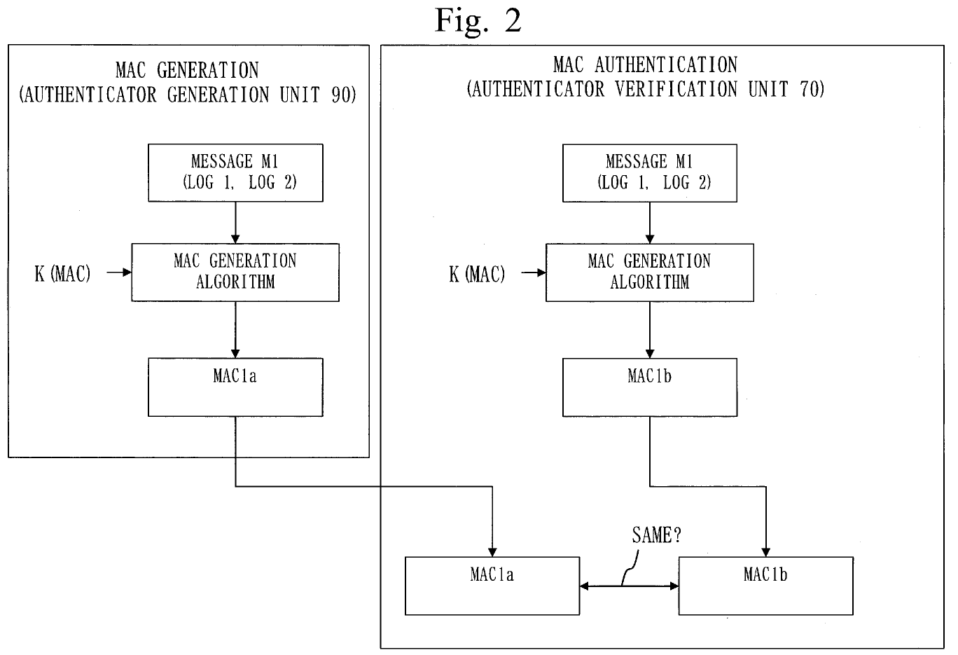

FIG. 2 illustrates generation of a MAC and authentication of a MAC when a MAC is used as an authenticator. Authenticators used in the following embodiments are not limited to MACs. It may be an authenticator in a system using a hash value. A MAC will be simply described with reference to FIG. 2.

First, generation of a MAC is described. In the attack detection device 501, the authenticator generation unit 90 generates a MAC 1a from a message M1 with a key K (MAC) by using a MAC generation algorithm. The key K (MAC) corresponds to the authentication key 601. The message M1 is a plurality of logs. For example, the message M1 is a log 1 and a log 2.

Next, authentication of the MAC will be discussed. The authenticator verification unit 70 generates a MAC 1b from the message M1 being logs with the key K (MAC) by using a MAC generation algorithm. The K (MAC) corresponds to the authentication key 601. The authenticator verification unit 70 collates the MAC 1a generated by the authenticator generation unit 90 with the MAC1b generated by the authenticator verification unit 70. When the MAC1a generated by the authenticator generation unit 90 matches the MAC 1b generated by the authenticator verification unit 70, the authenticator verification unit 70 determines that the log 1 and the log 2 are not falsified. When the MAC1a generated by the authenticator generation unit 90 does not match the MAC1b generated by the authenticator verification unit 70, the authenticator verification unit 70 determines that either or both of the log 1 and the log 2 is or are falsified.

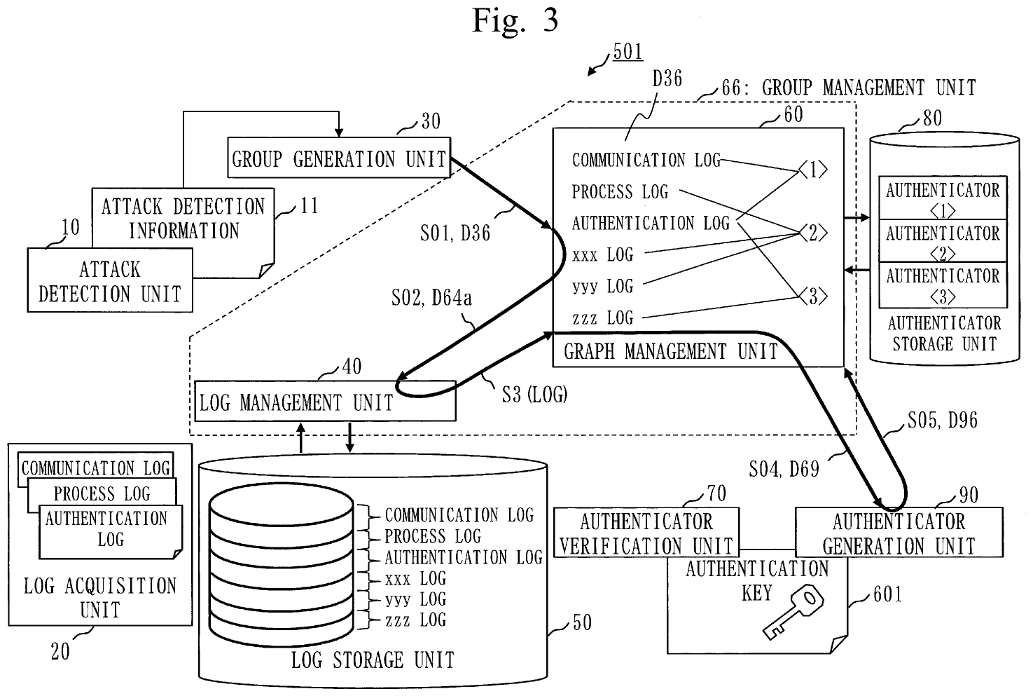

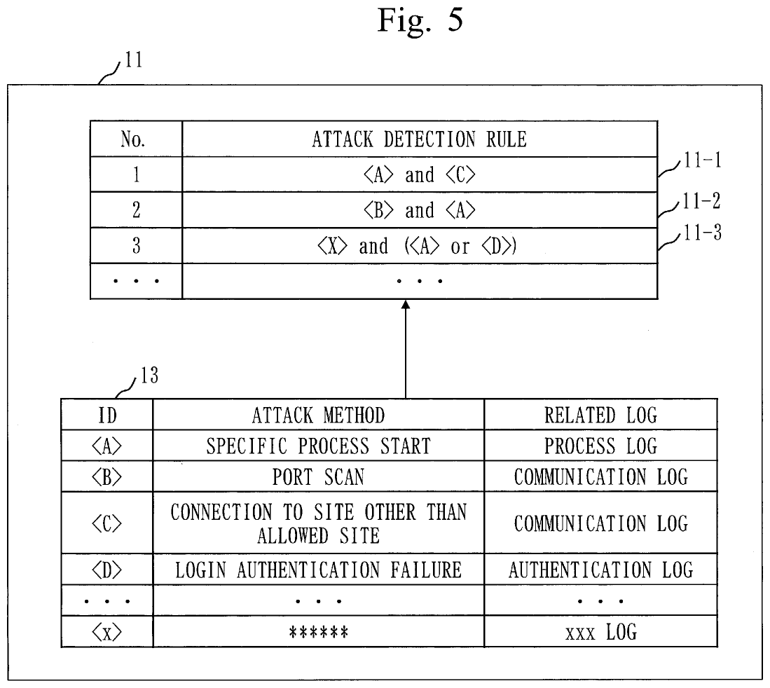

With reference to FIG. 3, FIG. 4 and FIG. 5, the authenticator graph D36 being a feature of the attack detection device 501 will be described.

FIG. 3 is a diagram to describe the authenticator graph D36.

FIG. 4 illustrates the authenticator graph D36 that the group generation unit 30 generates.

FIG. 5 illustrates the attack detection information 11 included in the attack detection unit 10.

As illustrated in FIG. 3, the group generation unit 30 generates an authenticator graph D36, and transmits the authenticator graph D36 generated to the graph management unit 60. The graph management unit 60 manages the authenticator graph D36. Details of FIG. 3 will be discussed later.

(Authenticator Graph D36)

The authenticator graph D36 is a correspondence information group including a plurality of pieces of correspondence information. As illustrated in FIG. 4, the authenticator graph D36 is a correspondence information group. The authenticator graph D36 includes a plurality of pieces of correspondence information. A piece of correspondence information associates a plurality of logs with identifier that identifies an authenticator generated by using the plurality of logs . In FIGS. 4, <1>, <2> and <3> indicate identifiers to identify authenticators. In FIG. 3, the identifier <1> corresponds to the authenticator <1>, the identifier <2> corresponds to the authenticator <2>, and the identifier <3> corresponds to the authenticator <3>. The correspondence between the identifier <1> and “a communication log and an authentication log” is correspondence information; the correspondence between the identifier <2> and “a process log, an xxx log and a yyy log” is correspondence information; and the correspondence between the identifier <3> and “an authentication log and a zzz log” is correspondence information.

(Attack Detection Information 11)

The group generation unit 30 generates the authenticator graph 36 based on the attack detection information 11. As illustrated in FIG. 5, the attack detection information 11 includes a plurality of attack detection rules such as attack detection rules 11-1, 11-2, 11-3, etc. The attack detection rules are expressed by a logical expression such as “and” and “or.” Each attack detection rule of the plurality of attack detection rules is associated with a plurality of logs via the attack method information 13.

A concrete description is provided below.

The group generation unit 30 refers to the attack detection rule 11-1, and recognizes that an attack method <A> is related to an attack method <C>. At the same time, with the attack method information 13, the group generation unit 30 recognizes that the attack method <A> is related to the process log, and the attack method <C> is related to the communication log. The group generation unit 30 reflects the result recognized from the attack detection rule 11-1 on the authenticator graph D36.

Similarly, the group generation unit 30 refers to the attack detection rule 11-2, and recognizes that the attack method <B> is related to the attack method <A>. At the same time, with the attack method information 13, the group generation unit 30 recognizes that the attack method <B> is related to the communication log, and the attack method <A> is related to the process log. The group generation unit 30 reflects the result recognized from the attack detection rule 11-2 on the authenticator graph D36. The group generation unit 30 repeats these, and generates an authenticator graph D36 from the recognition result for each detection rule.

With respect to the attack detection rule 11-3, when the log is referred to, there is a relation of “xxx log” and (“process log” or “authentication log”). As for this logical expression, the group generation unit 30 may relates all logs as “xxx log” and “process log” and “authentication log.” Alternatively, as the logical expression, the group generation unit 30 may divide and reflect on the authenticator graph D36 the relation in such a manner as “xxx log” with “process log”, and “xxx log” with “authentication log.”

FIG. 6 illustrates data exchanged between the components in the attack detection device 501. With reference to FIG. 6, the data exchanged in the attack detection device 501 will be described.

(D13)

The attack detection unit 10 transmits a detection information update notification D13 to the group generation unit 30. The detection information update notification D13 is a notification to notify that the attack detection information 11 is updated.

(D14)

The attack detection unit 10 transmits a log reference request D14 to the log management unit 40. When the attack detection unit 10 starts a detection process, the log reference request D14 is data to request to the log management unit 40 acquisition of a log to be referred to in order for the attack detection unit 10 to proceed with a further attack detection process.

(D24)

The log acquisition unit 20 transmits a log writing request D24 to the log management unit 40. The log writing request D24 requests writing of a log whose update has occurred.

(D36)

The group generation unit 30 transmits the authenticator graph D36 to the graph management unit 60. The authenticator graph D36 is as described in FIG. 4.

(D41, D46a, D46b, D46c, D47)

The log management unit 40 transmits a log D41 to the attack detection unit 10. The log management unit 40 transmits a log D46a to the graph management unit 60. The log management unit 40 transmits a log update notification D46b to the graph management unit 60. The log update notification D46b notifies a log updated. The log management unit 40 transmits to the graph management unit 60 an authenticator inquiry D46c. The authenticator inquiry D46c inquires an authenticator corresponding to a log requested with the log reference request D14 by the attack detection unit 10. The graph management unit 60 specifies the authenticator corresponding to the log requested with the log reference request D14 from the authenticator graph D36.

(D64a, D64b, D69)

The graph management unit 60 transmits a pertinent authenticator graph D64a to the log management unit 40. The pertinent authenticator graph D64a is a part of the authenticator graph D36 managed by the graph management unit 60. That is, it is partial correspondence information among all correspondence information included in the authenticator graph D36. As the pertinent authenticator graph D64a, the graph management unit 60 may transmit the authenticator graph D36. The graph management unit 60 transmits the authenticator D64b to the log management unit 40.

The graph management unit 60 transmits the authenticator D64b to the log management unit 40. The graph management unit 60 transmits the authenticator generation request D69 to the authenticator generation unit 90. The authenticator generation request D69 is data to request generation of an authenticator to the authenticator generation unit 90 by the graph management unit 60.

(D74)

The authenticator verification unit 70 transmits a verification result D74 to the log management unit 40. The verification result D74 corresponds to a collation result between MAC1a and MAC1b in FIG. 2.

(D96)

The authenticator generation unit 90 transmits an authenticator D96 generated to the graph management unit 60.

***Explanation of Operation***

The operation of the attack detection device 501 will be described hereinafter. The operation procedure of the attack detection device 501 corresponds to an attack detection method. A program to realize the operation of the attack detection device 501 corresponds to an attack detection program.

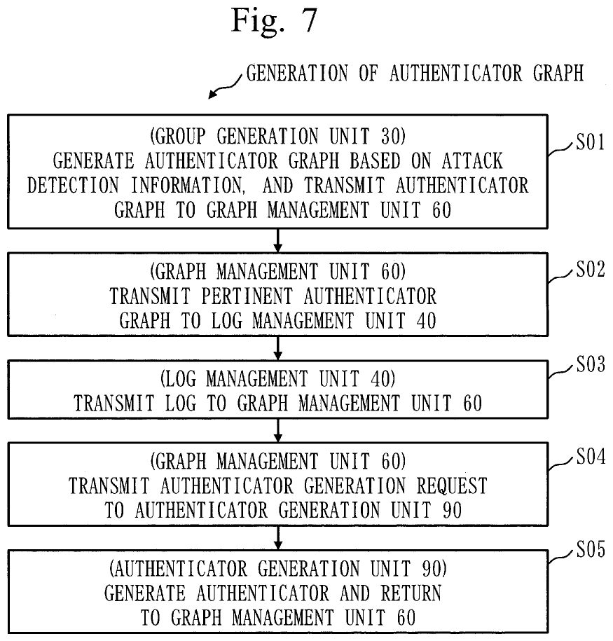

FIG. 7 is a flowchart illustrating an operation to generate the pertinent authenticator graph D64a by the attack detection device 501 as a preparatory step. Since FIG. 3 is also a diagram to supplement FIG. 7, description is made with reference to FIG. 7 and FIG. 3 on the operation to generate the authenticator graph 64a by the attack detection device 501 as the preparatory step.
(1) In step S01, the group generation unit 30 generates an authenticator graph being a correspondence information group based on attack detection rules indicated in FIG. 5. The attack detection rules are rules to detect a cyberattack, and rules to which a plurality of logs are corresponded. Specifically, the group generation unit 30 generates the authenticator graph D36 based on the attack detection information 11, and transmits the authenticator graph D36 to the graph management unit 60. Generation of the authenticator graph D36 by the group generation unit 30 is as follows. The attack detection unit 10 extracts related logs, for example, a communication log and a process log from the log management unit 40 based on the attack detection rules, and searches for existence of a trace of an “attack method” from those logs. For example, the attack detection unit 10 searches for a trace of “specific process start” from the process log, and a trace of “port scan” from the communication log. In this manner, there exist a plurality of logs which are referred to based on the attack detection rules. Then, the group generation unit 30 generates the authenticator graph D36 by using reference to a plurality of logs.
(2) In step S02, the graph management unit 60 transmits the pertinent authenticator graph D64a to the log management unit 40. The log management unit 40 recognizes correspondence between an authenticator and a log by receiving the pertinent authenticator graph D64a.
(3) In step S03, the log management unit 40 transmits an associated log in the pertinent authenticator graph D64a to the graph management unit 60.
(4) In step S04, the graph management unit 60 transmits the authenticator generation request D69 to the authenticator generation unit 90.
(5) In step S05, the authenticator generation unit 90 generates authenticators identified by identifiers for each identifier, from a plurality of logs obtained by the log management unit 40. The authenticator generation unit 90 generates an authenticator D96, and returns the authenticator D96 to the graph management unit 60. The graph management unit 60 stores the authenticator received from the authenticator generation unit 90 in the authenticator storage unit 80 and manages the received authenticator.

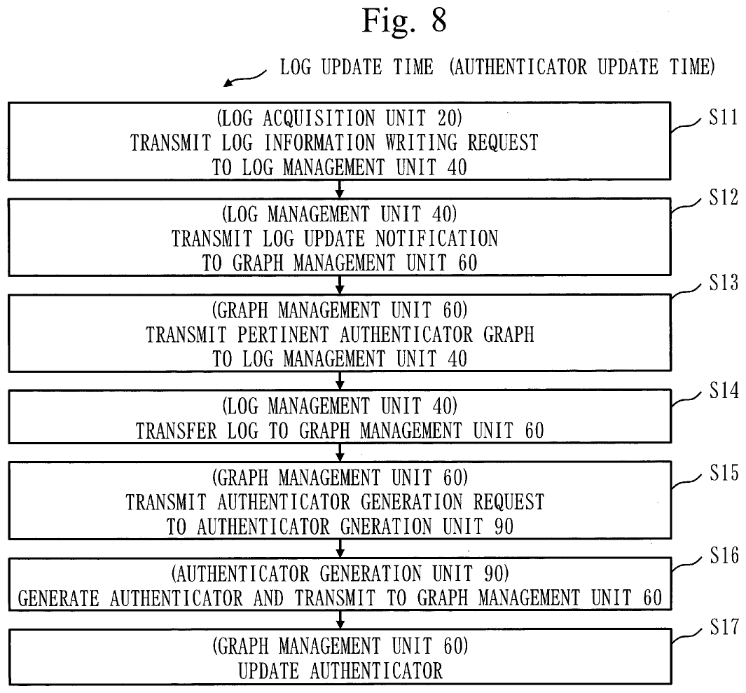

FIG. 8 is a flowchart of an operation to update an authenticator at the time of log update by the attack detection device 501.

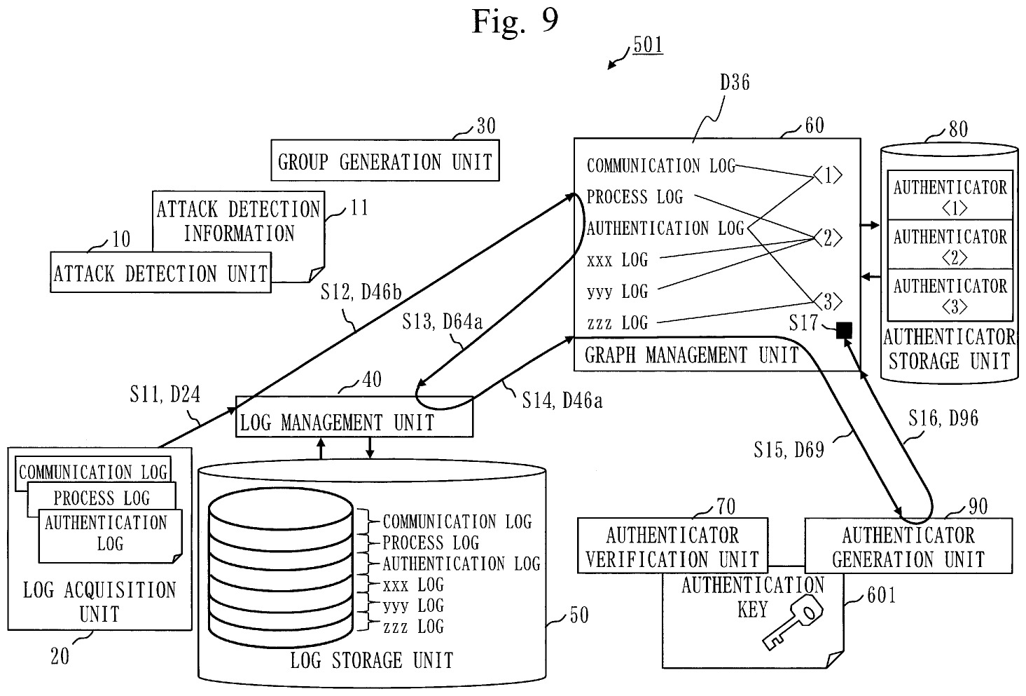

FIG. 9 is a diagram to supplement FIG. 8.
(1) In step S11, the log acquisition unit 20 transmits a log writing request D24 to the log management unit 40.
(2) In step S12, when the log writing request D24 is received, the log management unit 40 transmits a log update notification D46b to the graph management unit 60.
(3) In step S13, when the log update notification D46b is received, the graph management unit 60 transmits a pertinent authenticator graph D64a to the log management unit 40.
(4) In step S14, the log management unit 40 extracts a log indicated in the pertinent authenticator graph D64a from the log storage unit 50, and transfers a log 46a, the log extracted, to the graph management unit 60.
(5) In step S15, when a log corresponding to an identifier of an authenticator graph being a correspondence information group is updated, the graph management unit 60 acquires an update log indicating the log updated, and outputs an authenticator generation request to order generation of an authenticator identified by an identifier associated with the update log. Specifically, when the log 46a is received, the graph management unit 60 transmits the authenticator generation request D69 to the authenticator generation unit 90. The authenticator generation request D69 includes the log 46a.
(6) In step S16, when the authenticator generation request is output, the authenticator generation unit 90 generates the authenticator identified by the identifier associated with the update log in the authenticator graph being the correspondence information group by using the update log updated. Specifically, when the authenticator generation request D69 is received, the authenticator generation unit 90 generates the authenticator D96, and transmits the authenticator D96 to the graph management unit 60.
(7) In step S17, the graph management unit 60 manages the authenticator generated by using the update log. Specifically, the graph management unit 60 stores the authenticator D96 received in the authenticator storage unit 80, and updates an authenticator corresponding to the authenticator D96 to the authenticator D96.

FIG. 10 is a flowchart illustrating an operation of authenticator verification at the time when the attack detection device 501 detects an attack. FIG. 11 is a diagram to supplement FIG. 10.
(1) In step S21, the attack detection unit 10 outputs a log reference request to request a log to be referred to as needed. Specifically, the attack detection unit 10 transmits a log reference request D14 to the log management unit 40.
(2) In step S22, the log management unit 40 transmits an authenticator inquiry D46c to request an authenticator D64b associated with the log requested by the log reference request D14, to the graph management unit 60.
(3) In step S23, the graph management unit 60 refers to an authenticator graph being the correspondence information group and extracts an authenticator associated with the log requested by the log reference request. The graph management unit 60 transmits the authenticator D64b extracted to the log management unit 40.
(4) In step S24, the log management unit 40 transmits a verification request D47 to the authenticator verification unit 70. The verification request D47 is the authenticator D64b and a log to generate the authenticator D64b, specifically.
(5) In step S25, by using a plurality of logs associated with the authenticator extracted via the identifier of the correspondence information in the authenticator graph, the authenticator verification unit 70 generates a correspondence authenticator corresponding to the authenticator extracted. And the authenticator verification unit 70 outputs a verification result indicating whether it is successful by verifying the correspondence authenticator. The authenticator verification unit 70 transmits a verification result D74 to the log management unit 40.
(6) In step S26, when the verification result of validity by the authenticator verification unit 70 indicates validness, the log management unit 40 of the group management unit 66 outputs the log requested to be referred to by the log reference request D14 to the attack detection unit 10 in response to the log reference request D14.

Specifically, when the verification result D74 is “success,” the log management unit 40 transmits the log D41 requested by the log reference request D14 to the attack detection unit 10.

In this manner, the attack detection unit 10 acquires the log verified to be valid by the verification request generated due to the log reference request and determines existence of the cyberattack by using the log acquired. It is possible for the attack detection unit 10 that has acquired the log to refer to the log accompanying attack detection.

In step S21 through step S26 described above, with respect to a log other than the log requested by the log reference request D14 from the attack detection unit 10, it becomes highly likely that log writing for update is performed without waiting for writing.

For example, in FIG. 11, the log reference request D14 requests reference to the authentication log and the zzz log. At this time, it is assumed that updates occur in the communication log, the process log and the authentication log, and writing becomes necessary. Whereas it is impossible to write into an authentication log where an update occurs, it is possible to update the communication log and the process log.

FIG. 12 is a flowchart illustrating an operation of the attack detection device 501 at the time when the attack detection information 11 is updated.

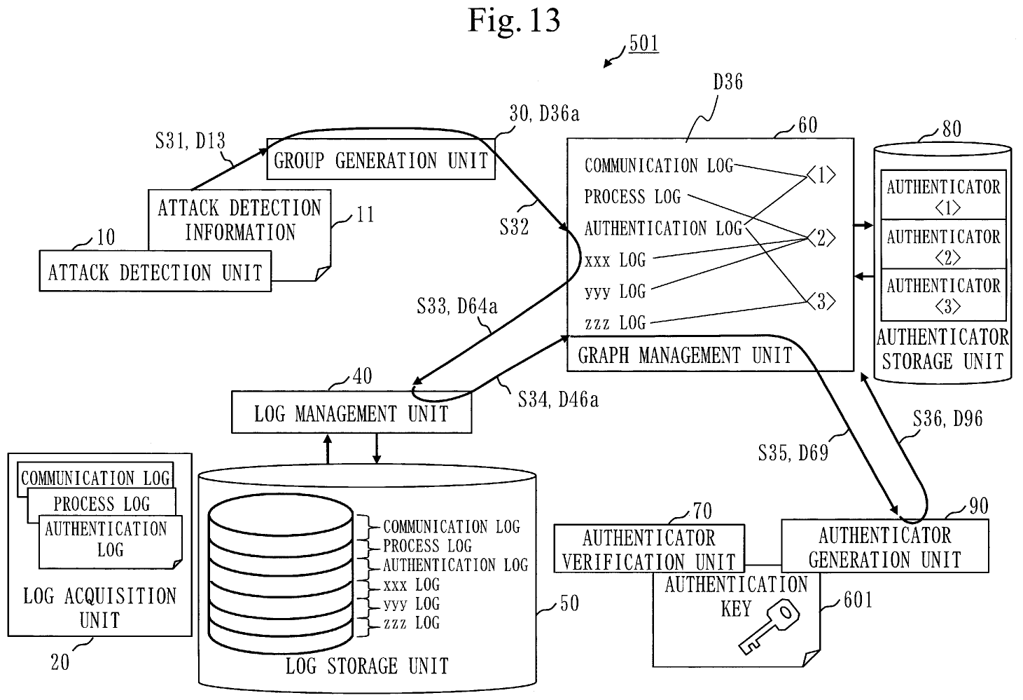

FIG. 13 is a diagram to supplement FIG. 12.
(1) In step S31, the group generation unit 30 receives the detection information update notification D13 from the attack detection unit 10. The detection information update notification D13 includes new attack detection information 11a updated.
(2) In step S32, the group generation unit 30 generates a new authenticator graph D36a based on the attack detection information 11a received, and transmits the authenticator graph D36a to the graph management unit 60.
(3) In step S33, when the authenticator graph D36a is received, the graph management unit 60 transmits the pertinent authenticator graph D64a, to the log management unit 40. The pertinent authenticator graph D64a is correspondence information which differs between the new authenticator graph D36a and the authenticator graph D36a that has been held.
(4) In step S34, when the pertinent authenticator graph D64a is received, the log management unit 40 transmits a log D46a that is associated with an identifier in the pertinent authenticator graph D64a, to the graph management unit 60.
(5) In step S35, when the log D46a is received, the graph management unit 60 transmits the authenticator generation request D69 to the authenticator generation unit 90. The authenticator generation request D69 includes the log D46a.
(6) In step S36, when the authenticator generation request D69 is received, the authenticator generation unit 90 generates an authenticator D96, and transmits the authenticator D96 to the graph management unit 60.

### Effect of First Embodiment

In the attack detection device 501 of the first embodiment, the group generation unit 30 generates the authenticator graph D36, and the graph management unit 60 manages the authentication graph D36. Therefore, it is possible to provide an authenticator management device to reduce the load for managing authenticators, and the time to wait for log writing.

As a detection method of log falsification, a method to assign an authenticator to each of a plurality of logs is considered. However, in this method, it is impossible to detect log deletion in a case wherein log deletion is falsified. In contrast, in the attack detection device 501 of the first embodiment, since one authenticator is generated from a plurality of logs, it is possible to detect falsification of log deletion.

Further, as a detection method of log falsification, a method to assign an authenticator to the whole of the plurality of logs is also considered. However, in this method, when logs are referred to due to detection of a cyberattack, the plurality of logs as a whole are used for verification of the authenticator; therefore, when any of the logs is updated and writing becomes necessary, it is impossible to write into the log, and the time to wait for log writing becomes long. On contrast, in the attack detection device 501 in the first embodiment, since each piece of correspondence information of a plurality of pieces of correspondence information and the authenticator are associated with one another and managed, it is possible to suppress elongation of waiting time for log writing.

### Second Embodiment

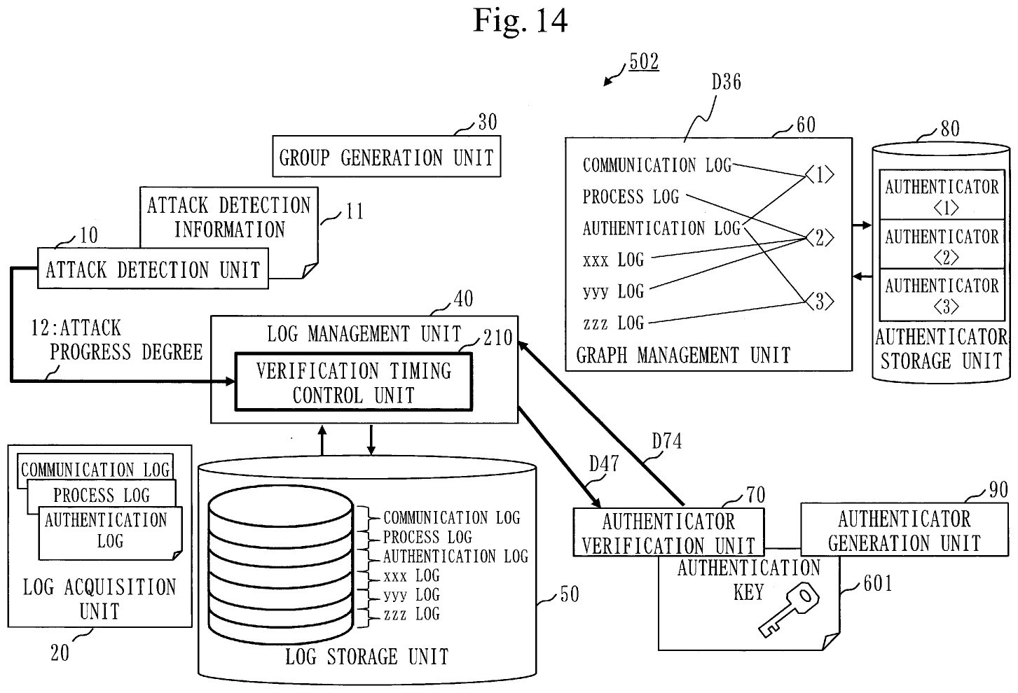

With reference to FIG. 14, the attack detection device 502 in the second embodiment will be described.

FIG. 14 illustrates a functional configuration of the attack detection device 502 in the second embodiment. The log management unit 40 of the attack detection device 502 includes a verification timing control unit 210. In the attack detection device 501, the authenticator verification unit 70 verifies an authenticator in a flow from step S21 through step S26 caused by a log reference request D14 received by the log management unit 40 from the attack detection unit 10. Because of this, a time lag is caused from when the log reference request D14 is received by when a log requested is transmitted to the attack detection unit 10 via a verification process. Therefore, in the attack detection device 502, irrespective of the log reference request D14 from the attack detection unit 10, the verification timing control unit 210 causes the authenticator verification unit 70 to “verify an authenticator” in a state asynchronous with the log reference request D14. Hereinafter, the operation of the verification timing control unit 210 will be described.

The attack detection unit 10 monitors a stage of progress of a cyberattack. The attack detection unit 10 determines the stage of progress of a cyberattack from the number of AND items determined to be true, or a proportion of AND items determined to be true, in AND items in the attack detection rules illustrated in FIG. 5, for example.

The verification timing control unit 210, in accordance with a stage of progress of the cyberattack, decides the plurality of logs and the authenticator to be included in the verification request D47, and controls a timing to output the verification request D47. The verification timing control unit 210 outputs the verification request D47 to request verification of an authenticator intermittently to the authenticator verification unit 70 in accordance with the stage of progress of the cyberattack monitored by the attack detection unit 10.

The authenticator verification unit 70 verifies the authenticator requested by the verification request D47, by using a plurality of logs that are associated with the authenticator requested by the verification request D47 via an identifier in correspondence information every time the verification request D47 is output.

A concrete explanation is given as follows. The verification timing control unit 210 receives an attack progress degree 12 detected by the attack detection unit 10 from the attack detection unit 10. The verification timing control unit 210 controls a verification request timing of an authenticator for each identifier of the authenticators described in the authenticator graph D36 in response to the attack progress degree 12. It is assumed that the value of the attack progress degree 12 changes as 10, 20, 30. The greater the value of the attack progress degree 12 is, the more the attack has been progressing.

For example, when the value of the attack progress degree is 10, the verification timing control unit 210 verifies the authenticator <1> which is associated with the identifier <1> of the authentication graph D 36. The verification timing control unit 210 acquires a communication log and an authentication log which are associated with the authenticator <1> from the log storage unit 50, and acquires the authenticator <1> from the graph management unit 60. The verification timing control unit 210 transmits the verification request D47 to the authenticator verification unit 70. The verification request D47 includes the authenticator <1>, the communication log and the authentication log. The authenticator verification unit 70 performs a verification process of the authenticator <1>, and transmits the verification result D74 to the verification timing control unit 210.

When the value of the attack progress degree 12 changes from 10 to 20, the verification timing control unit 210 verifies the authenticator <2> which is associated with the identifier <2> of the authenticator graph D36. The verification timing control unit 210 acquires a process log, an xxx log and a yyy log which are associated with the authenticator <2> from the log storage unit 50, and acquires the authenticator <2> from the graph management unit 60. The verification timing control unit 210 transmits the verification request D47 to the authenticator verification unit 70. The verification request D47 includes the authenticator <2>, the process log, the xxx log and the yyy log.

The authenticator verification unit 70 performs a verification process of the authenticator <2>, and transmits the verification result D74 to the verification timing control unit 210.

A case wherein the value of the attack progress degree 12 changes from 20 to 30 as well is the same as the case wherein the value of the attack progress degree 12 changes from 10 and 20.

### Effect of Second Embodiment

In the attack detection device 502 in the second embodiment, the verification timing control unit 210 makes the authenticator verification unit 70 verify the authenticator in response to the attack progress degree 12 in a state asynchronous with the log reference request D14. Therefore, it is possible to reduce the time lag which occurs at the time when the authenticator is verified due to the log reference request D14, from when an attack is caused by when a necessary log is referred to, in accordance with the progress degree of the attack.

### Third Embodiment

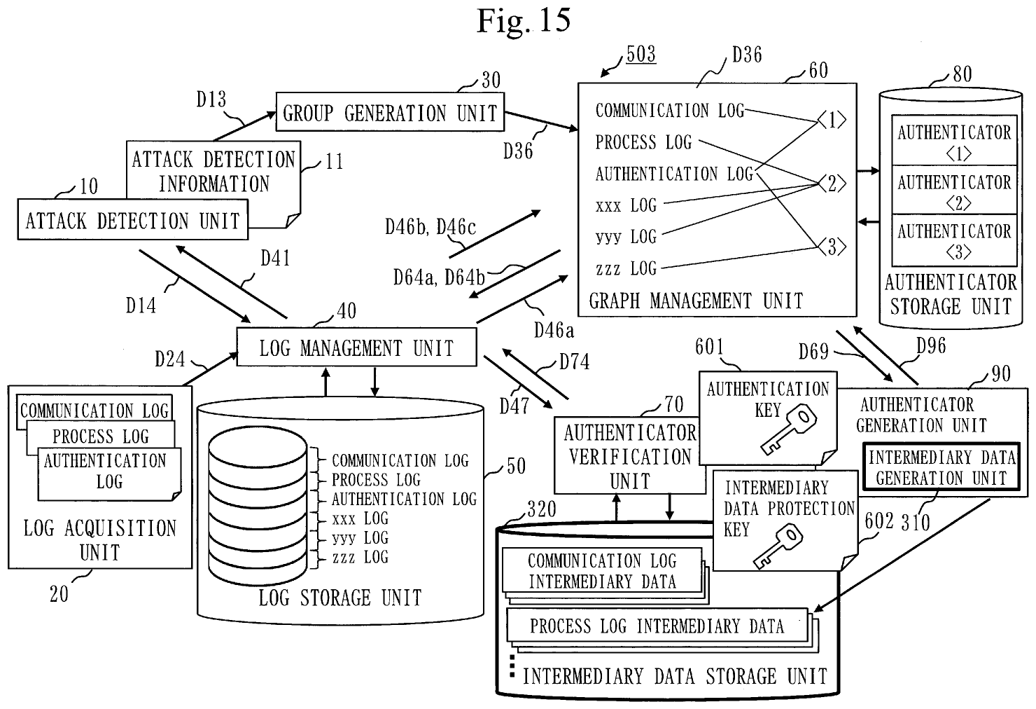

With reference to FIG. 15 through FIG. 20, description is made on an attack detection device 503 of the third embodiment. FIG. 15 illustrates a flow of data between functional components of the attack detection device 503. As illustrated in FIG. 15, the authenticator generation unit 90 includes an intermediary data generation unit 310. Further, the attack detection device 503 includes an intermediary data storage unit 320. These two parts are different from the attack detection device 501.

The intermediary data is data that appears before generation of an authenticator when the authenticator is generated. In other words, the intermediary data is data generated in the middle of a process during a plurality of processes when an authenticator is generated through the plurality of processes.

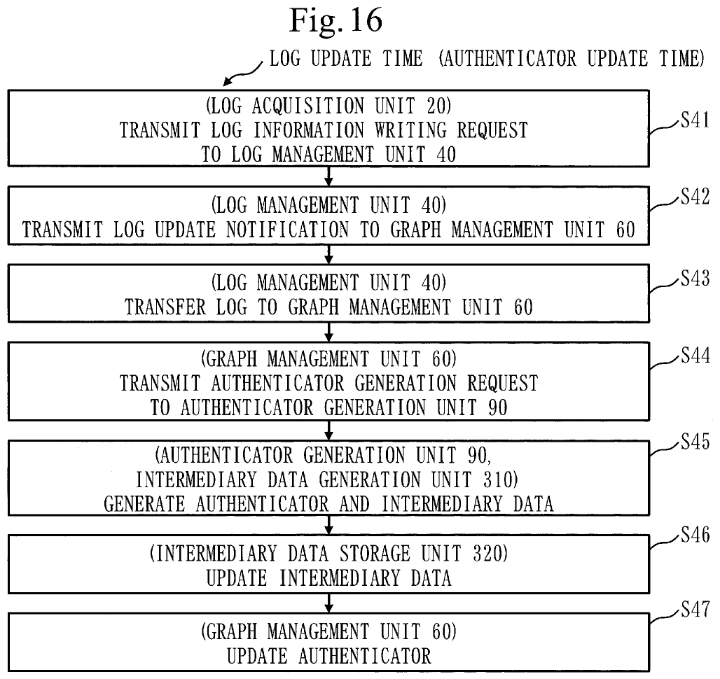

FIG. 16 is a flowchart illustrating an operation to generate an authenticator by the attack detection device 503.

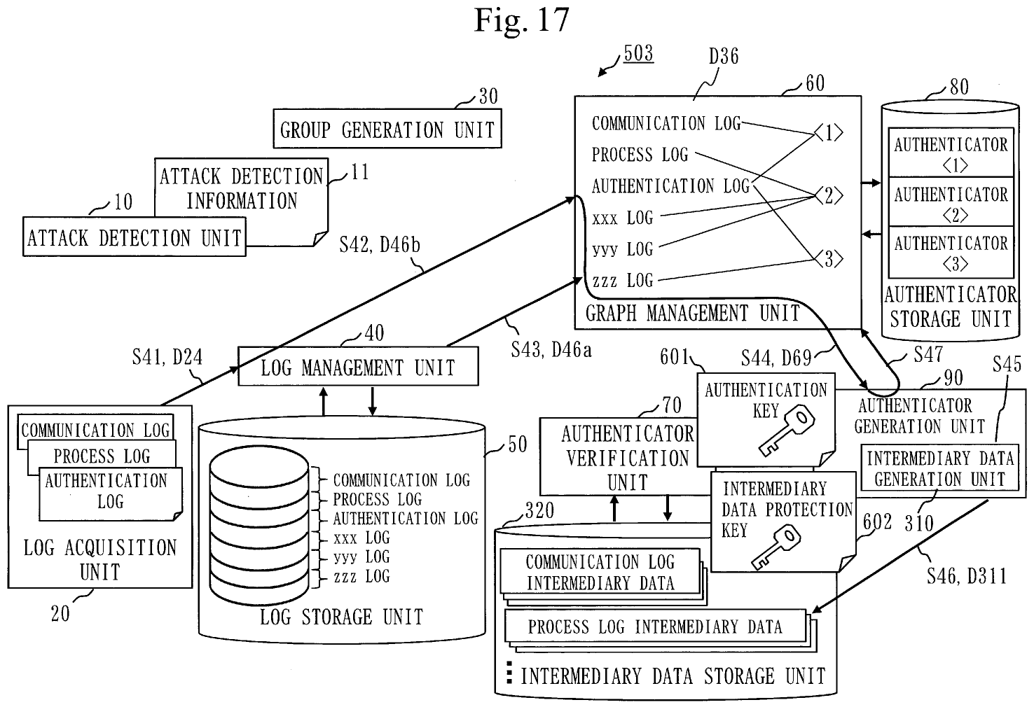

FIG. 17 is a diagram to supplement FIG. 16.

With reference to FIG. 16 and FIG. 17, description is made on a generation operation of an authenticator by the attack detection device 503.
(1) In step S41, the log acquisition unit 20 transmits a log writing request D24 to the log management unit 40.
(2) In step S42, when the log writing request D24 is received, the log management unit 40 transmits a log update notification D46b to the graph management unit 60.
(3) In step S43, the log management unit 40 transmits a log D46a updated by the log writing request D24 to the graph management unit 60.
(4) In step S44, when the log D46a is received, the graph management unit 60 transmits an authenticator generation request D69 to the authenticator generation unit 90.
(5) In step S45, the authenticator generation unit 90 uses intermediary data at the time of generation of an authenticator that has already been generated, and generates a new authenticator indicating an update value of the authenticator that has already been generated. The authenticator generation unit 90 stores the intermediary data of the authenticator in the intermediary data storage unit 320 being an intermediary data storage device. Specifically, when the authenticator generation request D69 is received, the intermediary data generation unit 310 of the authenticator generation unit 90 generates intermediary data 311 and an authenticator D96.

When the authenticator D96 is generated, the intermediary data generation unit 310 starts generation of the authenticator D96 from the intermediary data that has been generated in the past, and that is stored in the intermediary data storage unit 320.

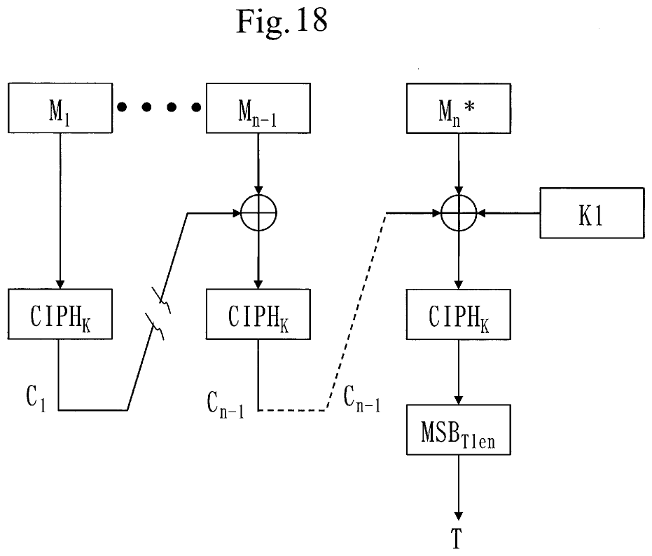

FIG. 18 indicates a state wherein the intermediary data generation unit 310 generates the authenticator D96 from the intermediary data that has been generated in the past. By using intermediary data Cn-1 retained, it is possible for the intermediary data generation unit 310 to process from the intermediary data Cn-1 when an authenticator Mn* is recalculated. That is, in FIG. 18, the process from an authenticator M1 to an authenticator Mn-1 becomes unnecessary. When intermediary data is generated, the intermediary data generation unit 310 stores the intermediary data generated in the intermediary data storage unit 320.
(6) In step S46, when the intermediary data 311 is generated, the intermediary data 311 is stored in the intermediary data storage unit 320 and the intermediary data is updated. The intermediary data 311 stored in the intermediary data storage unit 320 is used for generation of a next authenticator.
(7) In step S47, the intermediary data generation unit 310 transmits the authenticator D96 to the graph management unit 60. The graph management unit 60 stores the authenticator D96 in the authenticator storage unit 80, and updates an authenticator.

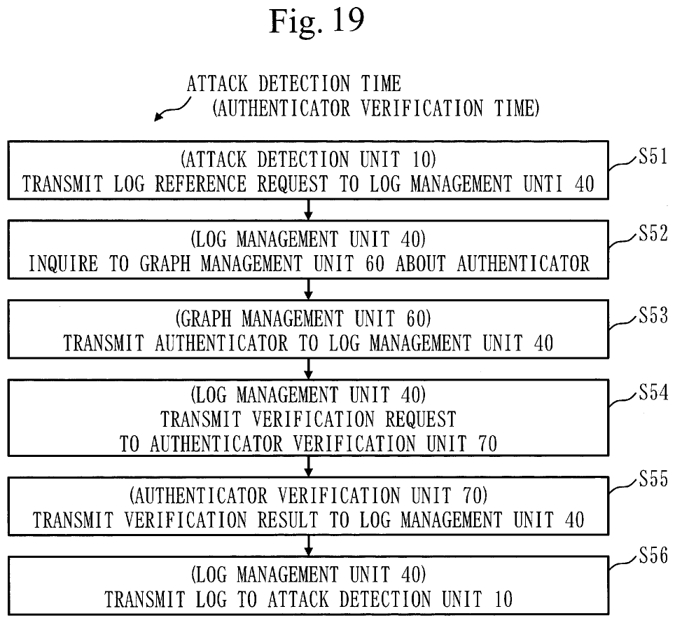

FIG. 19 is a flowchart illustrating an operation to verify an authenticator by the attack detection device 503.

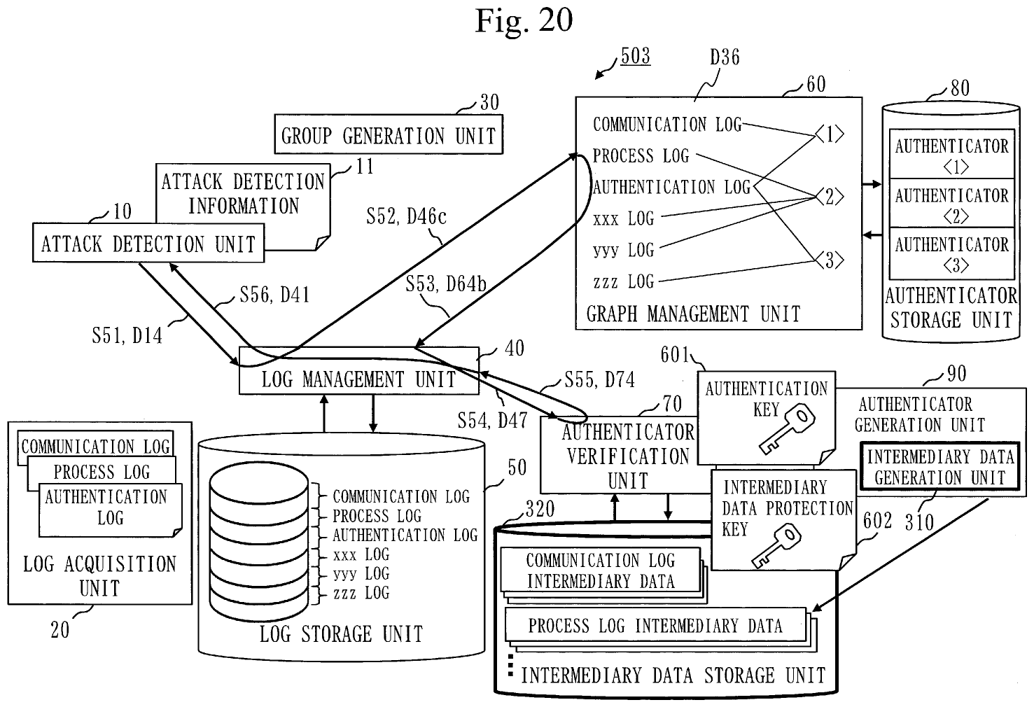

FIG. 20 is a diagram to supplement FIG. 19. With reference to FIG. 19 and FIG. 20, a verification operation of an authenticator by the attack detection device 503 will be described.
(1) In step S51, the attack detection unit 10 transmits a log reference request D14 to the log management unit 40.
(2) In step S52, when the log reference request D14 is received, the log management unit 40 transmits an authenticator inquiry D46c to the graph management unit 60.
(3) In step S53, when the authenticator inquiry D46c is received, the graph management unit 60 transmits an authenticator D64b to the log management unit 40.
(4) In step S54, when the authenticator D64b is received, the log management unit 40 transmits a verification request D47 to the authenticator verification unit 70.
(5) In step S55, when the verification request D47 is received, the authenticator verification unit 70 verifies an authenticator. It is possible for the authenticator verification unit 70 to generate an authenticator by using intermediary data, as illustrated in FIG. 18, as with the authenticator generation unit 90. A log and an index of verification object data are passed to the authenticator verification unit 70. The authenticator verification unit 70 starts a verification process from an intermediary value close to the index. For example, when the index points Mn, and the intermediary data close to the index is Cn-1, the process is resumed from a point of time when Cn-1 is output from CIPHK in FIG. 18. The content of the verification process after that is the same as step S25. The authenticator verification unit 70 transmits the verification result D74 to the log management unit 40.
(6) In step S56, when the verification result D74 is “success,” the log management unit 40 transmits a log D41 requested by the log reference request D14 to the attack detection unit 10.

In the attack detection device 503 in the third embodiment, since the authenticator generation unit 90 generates an authenticator using intermediary data, it is possible to reduce the time for waiting writing of a log for whose writing occurs at the time of generation of the authenticator. In the attack detection device 503 in the third embodiment, since the authenticator verification unit 70 also generates an authenticator by using intermediary data, it is possible to reduce the time for waiting writing of a log whose writing occurs at the time of authenticator verification.

### Fourth Embodiment

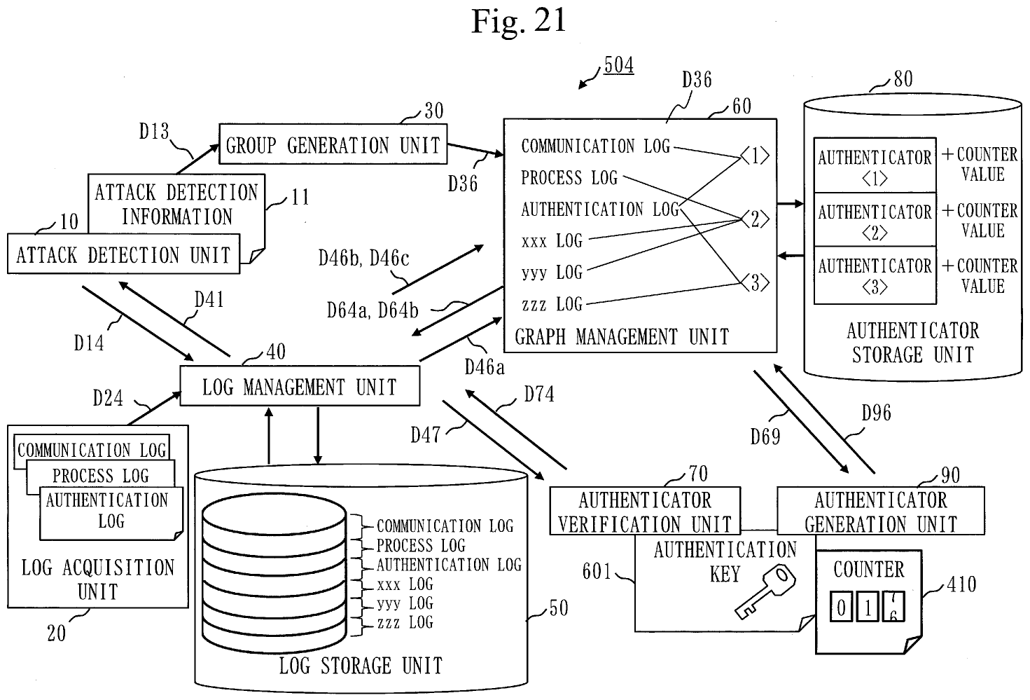

Description will be made on an attack detection device 504 in a fourth embodiment with reference to FIG. 21 through FIG. 24.

FIG. 21 indicates a flow of data in the attack detection device 504. The attack detection device 504 further includes a counter 410 to update a counter value in accordance with an update request relative to the attack detection device 501.

When an attack whereby the log storage unit 500 and the authenticator storage unit 80 are rolled back is received, it is impossible to detect a rollback. It is considered that the log storage unit 500 and the authenticator storage unit 80 are stored in a secure area; however, the cost becomes extremely high. Therefore, by the counter 410, the threat of a rollback attack is reduced.

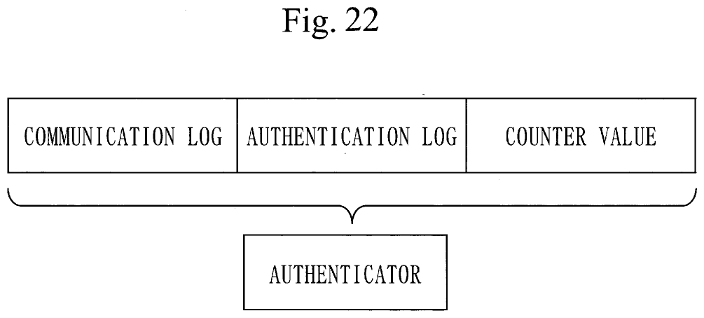

FIG. 22 illustrates a state wherein a counter value is reflected on an authenticator. As illustrated in FIG. 22, the authenticator generation unit 90 generates an authenticator based on a counter value and a log. In FIG. 22, an authenticator is generated from the counter value and the log. The “authenticator” +the counter value in the authenticator storage unit 80 of FIG. 21 means the content indicated in FIG. 22. As illustrated in FIG. 21 and FIG. 22, the authenticator is stored in the authenticator storage unit 80 in a state on which the counter value of the counter 410 at the time of generation of the authenticator is reflected. When the authenticator is generated, the counter value of the counter 410 is updated just before generation.

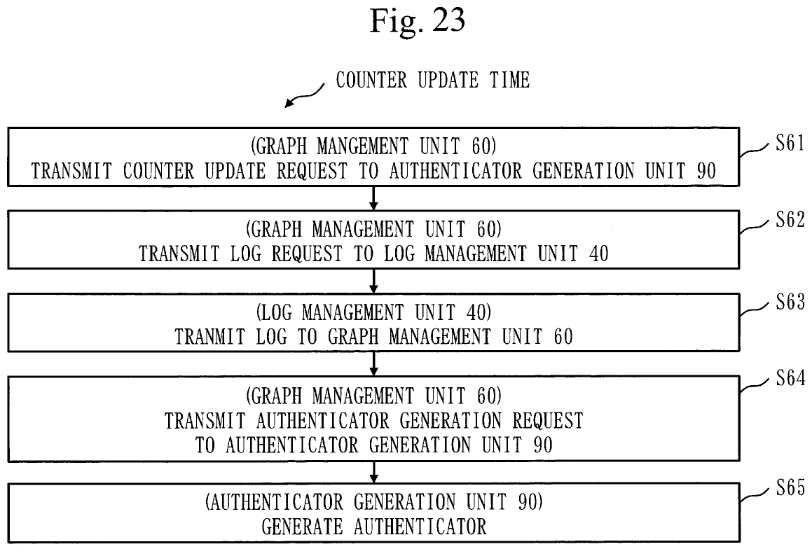

FIG. 23 is a flowchart illustrating an operation at the time when the counter value of the counter 410 is updated.

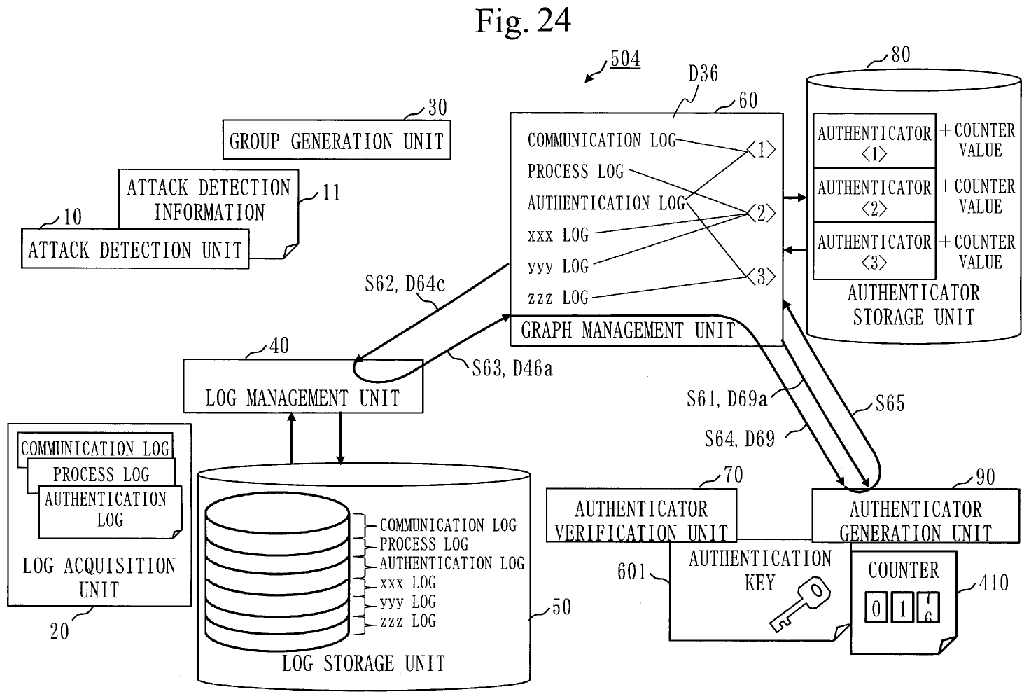

FIG. 24 is a diagram to supplement FIG. 23. With reference to FIG. 23 and FIG. 24, a verification operation of an authenticator by the attack detection device 503 will be described.
(1) In step S61, the graph management unit 60 transmits a counter update request D69a to the authenticator generation unit 90. When the counter update request D69a is received, the counter 410 updates the counter value.
(2) In step S62, the graph management unit 60 transmits a log request D64c to request a log associated in the authenticator graph D36 to the log management unit 40.
(3) In step S63, when the log request D69c is received, the log management unit 40 transmits a log D46a requested by the log request D64c to the graph management unit 60.
(4) In step S64, an authenticator generation request D69 is output. Specifically as follows.

The log management unit 40 of the group management unit 66 associates the counter value updated by an update request with the plurality of logs specified by the feature information, and manages the updated counter value and the plurality of logs. The graph management unit 60 of the group management unit 66 outputs the authenticator generation request D69 that includes the two or more logs included in the plurality of logs specified by the feature information and the counter value, and that requests generation of the authenticator. Specifically, when the graph management unit 60 receives a log D46a from the log management unit 40, the graph management unit 60 transmits an authenticator generation request D69 to the authenticator generation unit 90.
(5) In step S65, the authenticator generation unit 90 generates an authenticator based on the counter value and the log updated by an update request. Specifically, when the authenticator generation unit 90 receives the authenticator generation request D69, the authenticator generation unit 90 generates an authenticator D96 from the log D46a and the counter value, and transmits the authenticator D96 generated to the graph management unit 60. FIG. 22 illustrates a state wherein the authenticator D96 is generated from the log D46a and the counter value.

### Effect of Fourth Embodiment

The attack detection device 504 in the fourth embodiment generates an authenticator reflecting a counter value; therefore, it is possible to detect a rollback attack.

### Fifth Embodiment

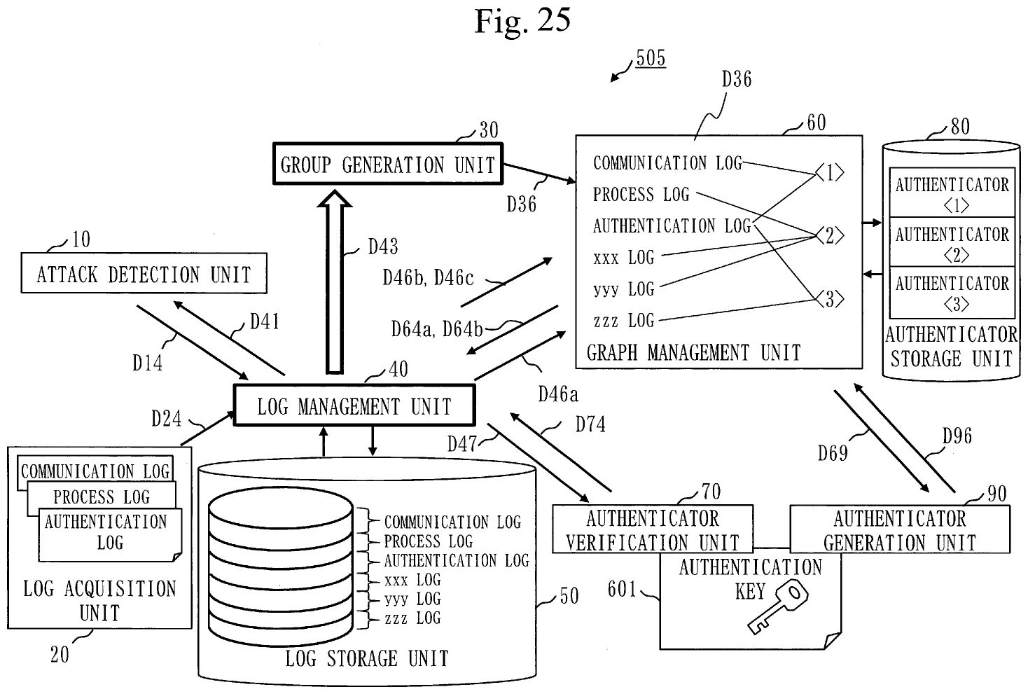

An attack detection device 505 in a fifth embodiment will be described with reference to FIG. 25 through FIG. 28. FIG. 25 illustrates a flow of data in the attack detection device 505. The feature of the attack detection device 505 is that the log management unit 40 transmits a log acquisition frequency D43 to the group generation unit 30, and the group generation unit 30 generates an authenticator graph D36 based on the log acquisition frequency D43.

The group generation unit 30 generates an authenticator graph being a correspondence information group based on an update frequency of a log which is associated with an authenticator via an identifier of correspondence information.

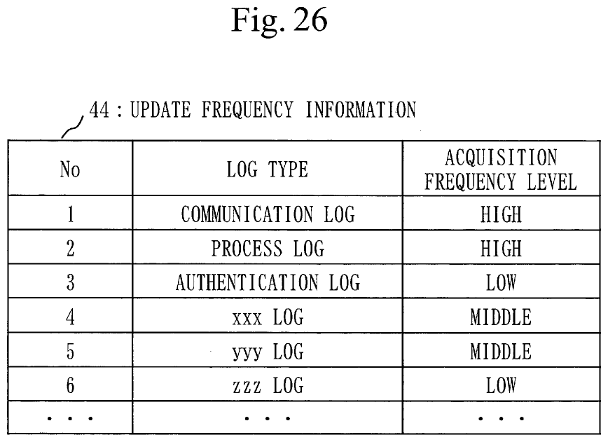

FIG. 26 is update frequency information 44 indicating an acquisition frequency of a log. The acquisition frequency of the log is an update frequency of the log. In the update frequency information 44 illustrated in FIG. 26, frequencies are described by type of log. The log management unit 40 obtains an acquisition frequency of a log as in FIG. 26. For example, it is possible for the log management unit 40 to calculate a frequency based on a log preceded for N seconds from the present time, from a log acquisition frequency file set beforehand.

FIG. 27 is a flowchart illustrating operation of the group generation unit 30 to generate an authenticator graph D36 based on the log acquisition frequency D43.

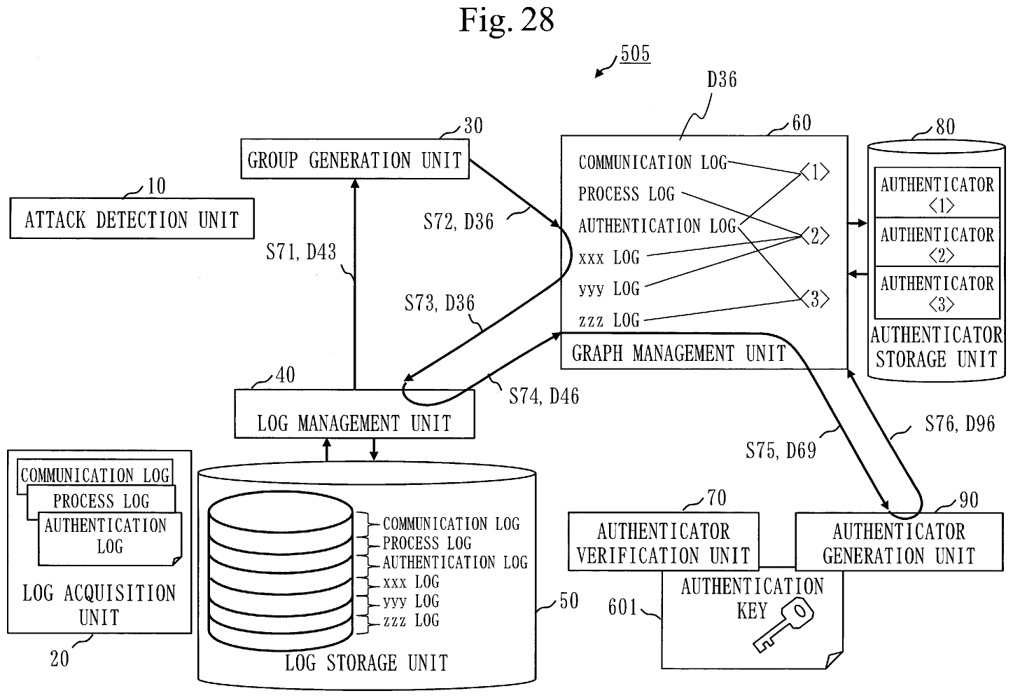

FIG. 28 is a diagram to supplement FIG. 27.
(1) In step S71, the log management unit 40 transmits a log acquisition frequency D43 to the group generation unit 30.
(2) In step S72, when the log acquisition frequency D43 is received, the group generation unit 30 generates an authenticator graph D36 based on the log acquisition frequency D43. The group generation unit 30 transmits the authenticator graph D36 generated to the graph management unit 60.
(3) In step S73, when the authenticator graph D36 is received, the graph management 60 transmits the authenticator graph D36 to the log management unit 40.
(4) In step S74, when the authenticator graph D36 is received, the log management unit 40 transmits a log D46 to the graph management unit 60.
(5) In step S75, when the log D46 is received, the graph management unit 60 transmits an authenticator request D69 to the authenticator generation unit 90.
(6) In step S76, when the authenticator generation request D69 is received, the authenticator generation unit 90 generates an authenticator D96, and transmits the authenticator D96 to the graph management unit 60.

In the attack detection device 505 in the fifth embodiment, the group generation unit 30 generates the authenticator graph D36 based on the log acquisition frequency D43. In the fifth embodiment, by preventing a log of high update frequency and a log of low update frequency from being associated with an identical authenticator, it is possible to reduce a generation time of authenticators more.

The above describes the first embodiment to the fifth embodiment of the present invention; however, it is also applicable to combine and perform two or more of these embodiments. Meanwhile, it is also applicable to partially perform one of these embodiments. Otherwise, it is also applicable to partially combine and perform two or more of these embodiments. The present invention is not limited to these embodiments, and various modifications are possible as needed.

### Sixth Embodiment

As a sixth embodiment, hardware components from the attack detection device 501 to the attack detection device 505 will be discussed.

***Explanation of Configuration***

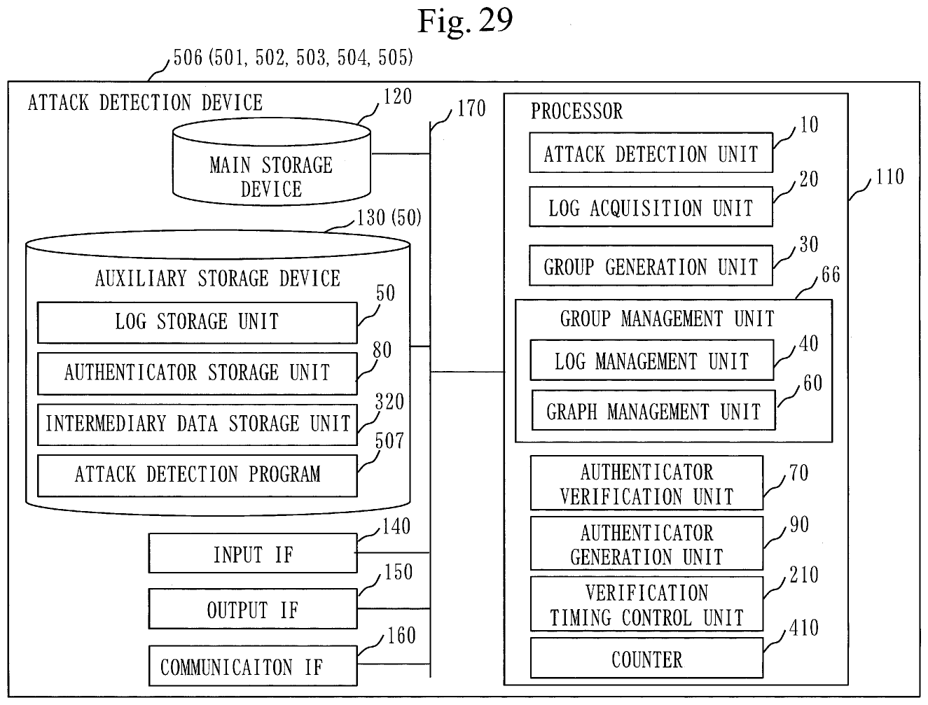

FIG. 29 illustrates a hardware configuration of an attack detection device 506. The attack detection device 506 includes functional components of the attack detection devices 501, 502, 503, 504 and 505. Description of the attack detection device 506 also applies to the attack detection device 501 to the attack detection device 505. With reference to FIG. 29, description will be made on the hardware configuration of the attack detection device 506.

The attack detection device 506 is a computer. The attack detection device 506 includes the processor 110. In addition to the processor 110, the attack detection device 506 includes other hardware components such as the main storage device 120, the auxiliary storage device 130, the input IF 140, the output IF 150 and the communication IF 160. The processor 110 is connected to the other hardware components via the signal line 170 to control the other hardware components.

The attack detection device 506 includes, as functional components, the attack detection unit 10, the log acquisition unit 20, the group generation unit 30, the log management unit 40, the graph management unit 60, the authenticator verification unit 70, the authenticator generation unit 90, the verification timing control unit 210 and the counter 410. Functions of the attack detection unit 10, the log acquisition unit 20, the group generation unit 30, the log management unit 40, the graph management unit 60, the authenticator verification unit 70, the authenticator generation unit 90, the verification timing control unit 210 and the counter 410 are realized by an attack detection program 507. The attack detection program 507 is stored in the auxiliary storage device 130.

The processor 110 is a device to execute the attack detection program 507. The attack detection program 507 is a program to realize the functions of the attack detection unit 10, the log acquisition unit 20, the group generation unit 30, the log management unit 40, the graph management unit 60, the authenticator verification unit 70, the authenticator generation unit 90, the verification timing control unit 210 and the counter 410. The processor 110 is an integrated circuit (IC) to perform an operation process. Specific examples of the processor 110 are a central processing unit (CPU), a digital signal processor (DSP) and a graphics processing unit (GPU).

The main storage device 120 is a storage device. Specific examples of the main storage device 120 are a static random access memory (SRAM) and a dynamic random access memory (DRAM). The main storage device 120 retains an operation result of the processor 110.

The auxiliary storage device 130 is a storage device to store data in a non-volatile manner. A schematic example of the auxiliary storage device 130 is a hard disk drive (HDD). Further, it is also applicable that the auxiliary storage device 130 is a portable recording medium such as a secure digital (SD) (registered trademark) memory card, a NAND flash memory, a flexible disk, an optical disc, a compact disc, a Blue-ray (registered trademark) disc and a digital versatile disk (DVD), etc. The auxiliary storage device 130 realizes the log storage unit 50, the authenticator storage unit 80 and the intermediary data storage unit 320.

The input IF 140 is a port into which data is input from each device. The output IF 150 is a port whereto various devices are connected, and through which data is output by the processor 110 to the various devices. The communication IF 160 is a communication port whereby processors communicate with other devices.

The processor 110 loads the attack detection program 507 into the main storage device 120 from the auxiliary storage device 130, and reads and executes the attack detection program 507 from the main storage device 120. In the main storage device 120, not only the attack detection program 507 but also an operating system (OS) is stored. The processor 110 executes the attack detection program 507 while executing the OS. The attack detection device 506 may include a plurality of processors replacing the processor 110. The plurality of processors share execution of the attack detection program 507. Each of the processors is a device to execute the attack detection program 507 as with the processor 110. The data, information, signal values and variable values used, processed or output by the attack detection program 507 are stored in the main storage device 120, the auxiliary storage device 130 or a register or a cache memory inside the processor 110.

The attack detection program 507 is a program to make a computer execute each process, each procedure or each step of “processes,” “procedures” or “steps,” with which “units” of the attack detection unit 10, the log acquisition unit 20, the group generation unit 30, the log management unit 40, the graph management unit 60, the authenticator verification unit 70, the authenticator generation unit 90 and the verification timing control unit 210 are replaced.

Further, an attack detection method is a method performed by executing the attack detection program 507 by the attack detection device 506 being a computer. It is applicable to provide the attack detection program 507 by storing the attack detection program 507 in a computer-readable recording medium, or as a program product.

<Supplement to Hardware Configuration>

In the attack detection device 506 of FIG. 29, the functions of the attack detection device 506 are realized by software; however, the functions of the attack detection device 506 may be realized by a hardware component.

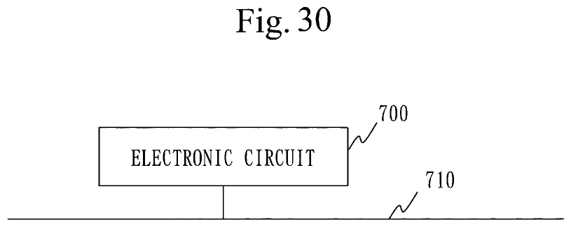

FIG. 30 illustrates a configuration to realize the functions of the attack detection device 506 by the hardware component. An electronic circuit 700 of FIG. 30 is a dedicated electronic circuit to realize the functions of the attack detection unit 10, the log acquisition unit 20, the group generation unit 30, the log management unit 40, the graph management unit 60, the authenticator verification unit 70, the authenticator generation unit 90, the verification timing control unit 210, the counter 410, the log storage unit 50, the authenticator storage unit 80 and the intermediary data storage unit 320 in the attack detection device 506. The electronic circuit 700 is connected to a signal line 710. The electronic circuit 700 is, specifically, a single circuit, a composite circuit, a processor that is made into a program, a processor that is made into a parallel program, a logic IC, a GA, an ASIC, or an FPGA. GA is an abbreviation for “gate array.” ASIC is an abbreviation for “application specific integrated circuit.” FPGA is an abbreviation for “field-programmable gate array.” The functions of the components of the attack detection device 506 may be realized by one electronic circuit, or may be realized dispersedly by a plurality of electronic circuits. Further, a partial function of the components of the attack detection device 506 may be realized by an electronic circuit, and the remaining functions may be realized by software.

Each of the processor 110 and the electronic circuit 700 is also called processing circuitry. In the attack detection device 506, the functions of the attack detection unit 10, the log acquisition unit 20, the group generation unit 30, the log management unit 40, the graph management unit 60, the authenticator verification unit 70, the authenticator generation unit 90, the verification timing control unit 210, the counter 410, the log storage unit 50, the authenticator storage unit 80 and the intermediary data storage unit 320 may be realized by processing circuitry.

### REFERENCE SIGNS LIST

10: attack detection unit; 11, 11a: attack detection information, 11-2, 11-2, 11-3: attack detection rule; 12: attack progress degree; 13: attack method information; 20: log acquisition unit; 30: group generation unit; 31: identifier graph; 40: log management unit; 50: log storage unit; 51: log database; 60: graph management unit; 66: group management unit; 70: authenticator verification unit; 80: authenticator storage unit; 90: authenticator generation unit; 110: processor; 120: main storage device; 130: auxiliary storage device; 140: input IF; 150: output IF; 160: communication IF; 170: signal line; 210: verification timing control unit; 310: intermediary data generation unit; 311: intermediary data; 320: intermediary data storage unit; 410: counter; 501, 502, 503, 504, 505, 506: attack detection device; 507: attack detection program; 601: authentication key; 602: intermediary data protection key; 700: electronic circuit; 710:

signal line; D14: log reference request; D13: detection information update notification; D24 log writing request; D36, D36a: authenticator graph; D41: log; D46a: log; D46b: log update notification; D46c: authenticator inquiry; D47: verification request; D43: log acquisition frequency; D64a: pertinent authenticator graph; D64b: authenticator; D64c: log request; D69: authenticator generation request; D69a: counter update request; D74: verification result; D96: authenticator.

1. An authenticator management device comprising:
processing circuitry to:
generate a correspondence information group including a plurality of pieces of correspondence information, a piece of correspondence information associating two or more logs included in a plurality of logs of feature information to represent a feature of a system being an object of a cyberattack, and to specify the plurality of logs, with an identifier to identify an authenticator to authenticate validity of the two or more logs;
output an authenticator generation request that includes the two or more logs indicated in the piece of correspondence information, and that requests generation of an authenticator identified by the identifier indicated in the piece of correspondence information, and to output, by referring to the correspondence information group in a case wherein a log reference request to request a log to be referred to is received, a verification request that includes a plurality of logs corresponding to the identifier corresponding to the log requested to be referred to by the log reference request, and the authenticator corresponding to the log requested to be referred to by the log reference request via the identifier;
generate an authenticator identified by the identifier indicated in the piece of correspondence information by using the two or more logs included in the authenticator generation request; and
verify validity of the plurality of logs included in the verification request by using the authenticator and the plurality of logs included in the verification request, and output a verification result wherein
the feature information is attack detection information wherein a plurality of logs are associated with each rule of a plurality of rules to detect the cyberattack.

2. An authenticator management device comprising:
processing circuitry to:
generate a correspondence information group including a plurality of pieces of correspondence information, a piece of correspondence information associating two or more logs included in a plurality of logs of feature information to represent a feature of a system being an object of a cyberattack, and to specify the plurality of logs, with an identifier to identify an authenticator to authenticate validity of the two or more logs;
output an authenticator generation request that includes the two or more logs indicated in the piece of correspondence information, and that requests generation of an authenticator identified by the identifier indicated in the piece of correspondence information, and to output, by referring to the correspondence information group in a case wherein a log reference request to request a log to be referred to is received, a verification request that includes a plurality of logs corresponding to the identifier corresponding to the log requested to be referred to by the log reference request, and the authenticator corresponding to the log requested to be referred to by the log reference request via the identifier;
generate an authenticator identified by the identifier indicated in the piece of correspondence information by using the two or more logs included in the authenticator generation request; and
verify validity of the plurality of logs included in the verification request by using the authenticator and the plurality of logs included in the verification request, and to output a verification result wherein
the processing circuitry, in accordance with a stage of progress of the cyberattack, decides the plurality of logs and the authenticator to be included in the verification request, and controls a timing to output the verification request.

3. The authenticator management device as defined in claim 2, wherein the feature information is update frequency information wherein an update frequency of the plurality of logs is registered.

4. The authenticator management device as defined in claim 1, wherein the processing circuitry outputs, when the verification result of the validity indicates validness, the log requested to be referred to by the log reference request in response to the log reference request.

5. The authenticator management device as defined in claim 1, wherein the processing circuitry generates, by using intermediary data at a generation time of the authenticator that has already been generated, a new authenticator indicating an update value of the authenticator that has already been generated.

6. The authenticator management device as defined in claim 5, wherein the processing circuitry stores the intermediary data of the authenticator in an intermediary data storage device.

7. The authenticator management device as defined in claim 1, wherein
the processing circuitry updates a counter value in accordance with an update request, associates the counter value updated by the update request with the plurality of logs specified by the feature information and manages the counter value updated by the update request and the plurality of logs specified by the feature information, and outputs an authenticator generation request that includes the two or more logs included in the plurality of logs specified by the feature information and the counter value, and that requests generation of the authenticator.

8. The authenticator management device as defined in claim 1, wherein
the processing circuitry outputs the log reference request, acquires the log verified to be valid by the verification request generated due to the log reference request, and determines existence of the cyberattack by using the log acquired.

9. A non-transitory computer readable medium storing an authentication management program for causing a computer to perform:
a group generation process to generate a correspondence information group including a plurality of pieces of correspondence information, a piece of correspondence information associating two or more logs included in a plurality of logs of feature information to represent a feature of a system being an object of a cyberattack, and to specify the plurality of logs, with an identifier to identify an authenticator to authenticate validity of the two or more logs;
a group management process to output an authenticator generation request that includes the two or more logs indicated in the piece of correspondence information, and that requests generation of an authenticator identified by the identifier indicated in the piece of correspondence information, and to output, by referring to the correspondence information group in a case wherein a log reference request to request a log to be referred to is received, a verification request that includes a plurality of logs corresponding to the identifier corresponding to the log requested to be referred to by the log reference request, and the authenticator corresponding to the log requested to be referred to by the log reference request via the identifier;
an authenticator generation process to generate an authenticator identified by the identifier indicated in the piece of correspondence information by using the two or more logs included in the authenticator generation request; and
an authenticator verification process to verify validity of the plurality of logs included in the verification request by using the authenticator and the plurality of logs included in the verification request, and to output a verification result, wherein the feature information is attack detection information wherein a plurality of logs are associated with each rule of a plurality of rules to detect the cyberattack.

10. A non-transitory computer readable medium storing an authentication management program for causing a computer to perform:
a group generation process to generate a correspondence information group including a plurality of pieces of correspondence information, a piece of correspondence information associating two or more logs included in a plurality of logs of feature information to represent a feature of a system being an object of a cyberattack, and to specify the plurality of logs, with an identifier to identify an authenticator to authenticate validity of the two or more logs;
a group management process to output an authenticator generation request that includes the two or more logs indicated in the piece of correspondence information, and that requests generation of an authenticator identified by the identifier indicated in the piece of correspondence information, and to output, by referring to the correspondence information group in a case wherein a log reference request to request a log to be referred to is received, a verification request that includes a plurality of logs corresponding to the identifier corresponding to the log requested to be referred to by the log reference request, and the authenticator corresponding to the log requested to be referred to by the log reference request via the identifier;
an authenticator generation process to generate an authenticator identified by the identifier indicated in the piece of correspondence information by using the two or more logs included in the authenticator generation request; and
an authenticator verification process to verify validity of the plurality of logs included in the verification request by using the authenticator and the plurality of logs included in the verification request, and to output a verification result, and further causing the computer to perform, in the group management process, a verification timing control process, in accordance with a stage of progress of the cyberattack, to decide the plurality of logs and the authenticator to be included in the verification request, and to control a timing to output the verification request.

11. An authenticator management method comprising:
generating a correspondence information group including a plurality of pieces of correspondence information, a piece of correspondence information associating two or more logs included in a plurality of logs of feature information to represent a feature of a system being an object of a cyberattack, and to specify the plurality of logs, with an identifier to identify an authenticator to authenticate validity of the two or more logs;
outputting an authenticator generation request that includes the two or more logs indicated in the piece of correspondence information, and that requests generation of an authenticator identified by the identifier indicated in the piece of correspondence information, and outputting, by referring to the correspondence information group in a case wherein a log reference request to request a log to be referred to is received, a verification request that includes a plurality of logs corresponding to the identifier corresponding to the log requested to be referred to by the log reference request, and the authenticator corresponding to the log requested to be referred to by the log reference request via the identifier;
generating an authenticator identified by the identifier indicated in the piece of correspondence information by using the two or more logs included in the authenticator generation request; and
verifying validity of the plurality of logs included in the verification request by using the authenticator and the plurality of logs included in the verification request, and outputting a verification result, wherein the feature information is attack detection information wherein a plurality of logs are associated with each rule of a plurality of rules to detect the cyberattack.

12. An authenticator management method comprising:
generating a correspondence information group including a plurality of pieces of correspondence information, a piece of correspondence information associating two or more logs included in a plurality of logs of feature information to represent a feature of a system being an object of a cyberattack, and to specify the plurality of logs, with an identifier to identify an authenticator to authenticate validity of the two or more logs;
outputting an authenticator generation request that includes the two or more logs indicated in the piece of correspondence information, and that requests generation of an authenticator identified by the identifier indicated in the piece of correspondence information, and outputting, by referring to the correspondence information group in a case wherein a log reference request to request a log to be referred to is received, a verification request that includes a plurality of logs corresponding to the identifier corresponding to the log requested to be referred to by the log reference request, and the authenticator corresponding to the log requested to be referred to by the log reference request via the identifier;
generating an authenticator identified by the identifier indicated in the piece of correspondence information by using the two or more logs included in the authenticator generation request; and
verifying validity of the plurality of logs included in the verification request by using the authenticator and the plurality of logs included in the verification request, and outputting a verification result, and further,
in accordance with a stage of progress of the cyberattack, deciding the plurality of logs and the authenticator to be included in the verification request, and controlling a timing to output the verification request.
